(19) United States
(12) Patent Application Publication
(10) Pub. No.: US 2026/0063868 A1
(43) Pub. Date: Mar. 5, 2026

(54) OPTICAL SYSTEM AND IMAGING APPARATUS INCLUDING THE SAME

(71) Applicant: CANON KABUSHIKI KAISHA, Tokyo (JP)

(72) Inventor: TAKAHIRO SAITO, Tochigi (JP)

(21) Appl. No.: 19/301,201

(22) Filed: Aug. 15, 2025

(30) Foreign Application Priority Data
Aug. 28, 2024 (JP) 2024-146479

(51) Int. Cl. G02B 9/12

(52) U.S. Cl. CPC G02B 9/12

(57) ABSTRACT

A system comprising a front lens unit having positive refractive power, a first focusing unit having positive refractive power, and a rear lens unit, arranged in order from an object side to an image side, wherein, during focusing from infinity to a close distance, the first focusing unit moves with respect to an image plane so that a space between the front lens unit and the first focusing unit and a space between the first focusing unit and the rear lens unit change, wherein, during focusing from infinity to a close distance, the rear lens unit remains stationary with respect to the image plane, wherein an aperture stop is included and arranged within the front lens unit or adjacent to an image side of the front lens unit, wherein the front lens unit includes a positive lens Gp, and wherein a predetermined inequality is satisfied.

### BACKGROUND

### Field of the Technology

The aspect of the embodiments relates to an optical system that can be used in an imaging apparatus, such as a digital video camera, a digital still camera, a broadcasting camera, a silver-halide film camera, a monitoring camera, or an in-vehicle camera, and relates to an imaging apparatus including the same.

### Description of the Related Art

In recent years, an optical system with a high aperture ratio for use in an imaging apparatus, such as a digital still camera or a video camera, that uses a solid-state image sensor is required to be a compact optical system in which various aberrations are effectively corrected to achieve high image quality. Japanese Patent Laid-Open No. 2019-152773 describes an optical system consisting of a first lens unit, a second lens unit, and a third lens unit, arranged in order from an object side to an image side. The second lens unit is configured to move with respect to an image plane during focusing, and an aperture stop is arranged in the second lens unit.

### SUMMARY

A system comprising a front lens unit having positive refractive power, a first focusing unit having positive refractive power, and a rear lens unit, arranged in order from an object side to an image side, wherein, during focusing from infinity to a close distance, the first focusing unit moves with respect to an image plane so that a space between the front lens unit and the first focusing unit and a space between the first focusing unit and the rear lens unit change, wherein, during focusing from infinity to a close distance, the rear lens unit remains stationary with respect to the image plane, wherein an aperture stop is included and arranged within the front lens unit or adjacent to an image side of the front lens unit, wherein the front lens unit includes a positive lens Gp, and wherein the following inequality is satisfied:

$$0.07 < Δθ gFp < 0.250 ,$$

where νdp is an Abbe number of a material of the positive lens Gp, θgFp is a partial dispersion ratio, ΔθgFp is an anomalous partial dispersibility, ΔθgFp=θgFp−(B3×νdp³+B2×νdp²+B1×νdp+B0), B3=−1.665×10⁻⁷, B2=5.213×10⁻⁵, B1=−5.656×10⁻³, and B0=7.278×10⁻¹.

Further, according to another aspect of the embodiments, a system comprises a front lens unit having positive refractive power, a first focusing unit having positive refractive power, and a rear lens unit, arranged in order from an object side to an image side, and during focusing from infinity to a close distance, the first focusing unit moves with respect to an image plane so that a space between the front lens unit and the first focusing unit and a space between the first focusing unit and the rear lens unit change, and the image-side focusing unit includes at least two negative lenses.

Features of the disclosure will become apparent from the following description of embodiments with reference to the attached drawings. The following description of embodiments is described by way of example.

### BRIEF DESCRIPTION OF THE DRAWINGS

FIG. 1 a is a cross-sectional view illustrating an optical system according to a first embodiment that is focused on an object at infinity.

FIG. 2A is a longitudinal aberration diagram illustrating the optical system according to the first embodiment that is focused at infinity, and FIG. 2B is a longitudinal aberration diagram illustrating the optical system according to the first embodiment that is focused at a distance corresponding to a lateral magnification of −0.1.

FIG. 3 is a cross-sectional view illustrating an optical system according to a second embodiment that is focused on an object at infinity.

FIG. 4A is a longitudinal aberration diagram illustrating the optical system according to the second embodiment that is focused at infinity, and FIG. 4B is a longitudinal aberration diagram illustrating the optical system according to the second embodiment that is focused at a distance corresponding to a lateral magnification of −0.1.

FIG. 5 is a cross-sectional view illustrating an optical system according to a third embodiment that is focused on an object at infinity.

FIG. 6A is a longitudinal aberration diagram illustrating the optical system according to the third embodiment that is focused at infinity, and FIG. 6B is a longitudinal aberration diagram illustrating the optical system according to the third embodiment that is focused at a distance corresponding to a lateral magnification of −0.1.

FIG. 7 is a cross-sectional view illustrating an optical system according to fourth embodiment that is focused on an object at infinity.

FIG. 8A is a longitudinal aberration diagram illustrating the optical system according to the fourth embodiment that is focused at infinity, and FIG. 8B is a longitudinal aberration diagram illustrating the optical system according to the fourth embodiment that is focused at a distance corresponding to a lateral magnification of −0.1.

FIG. 9 is a cross-sectional view illustrating an optical system according to a fifth embodiment that is focused on an object at infinity.

FIG. 10A is a longitudinal aberration diagram illustrating the optical system according to the fifth embodiment that is focused at infinity, and FIG. 10B is a longitudinal aberration diagram illustrating the optical system according to the fifth embodiment that is focused at a distance corresponding to a lateral magnification of −0.1.

FIG. 11 is a cross-sectional view illustrating an optical system according to a sixth embodiment that is focused on an object at infinity.

FIG. 12A is a longitudinal aberration diagram illustrating the optical system according to the sixth embodiment that is focused at infinity, and FIG. 12B is a longitudinal aberration diagram illustrating the optical system according to the sixth embodiment that is focused at a distance corresponding to a lateral magnification of −0.1.

FIG. 13 is a cross-sectional view illustrating an optical system according to a seventh embodiment that is focused on an object at infinity.

FIG. 14A is a longitudinal aberration diagram illustrating the optical system according to the seventh embodiment that is focused at infinity, and FIG. 14B is a longitudinal aberration diagram illustrating the optical system according to the seventh embodiment that is focused at a distance corresponding to a lateral magnification of −0.1.

FIG. 15 is a cross-sectional view illustrating an optical system according to an eighth embodiment that is focused on an object at infinity.

FIG. 16A is a longitudinal aberration diagram illustrating the optical system according to the eighth embodiment that is focused at infinity, and FIG. 16B is a longitudinal aberration diagram illustrating the optical system according to the eighth embodiment that is focused at a distance corresponding to a lateral magnification of −0.1.

FIG. 17 is a schematic diagram illustrating an imaging apparatus.

FIG. 18 is a schematic diagram illustrating a lens apparatus.

### DESCRIPTION OF THE EMBODIMENTS

Embodiments disclosed in the present specification will be described in detail below with reference to the drawings. It should be noted that, for convenience, each drawing may be illustrated at a scale different from actual sizes. Further, the same reference numeral is assigned to corresponding components in the drawings, and redundant descriptions are omitted.

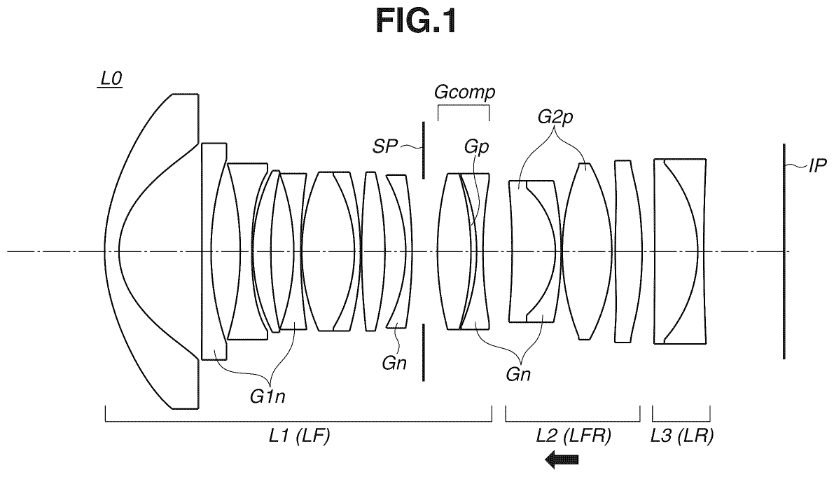

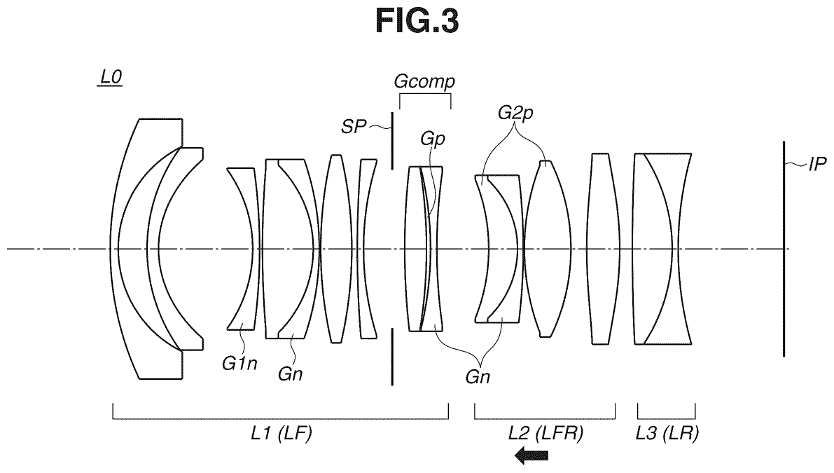

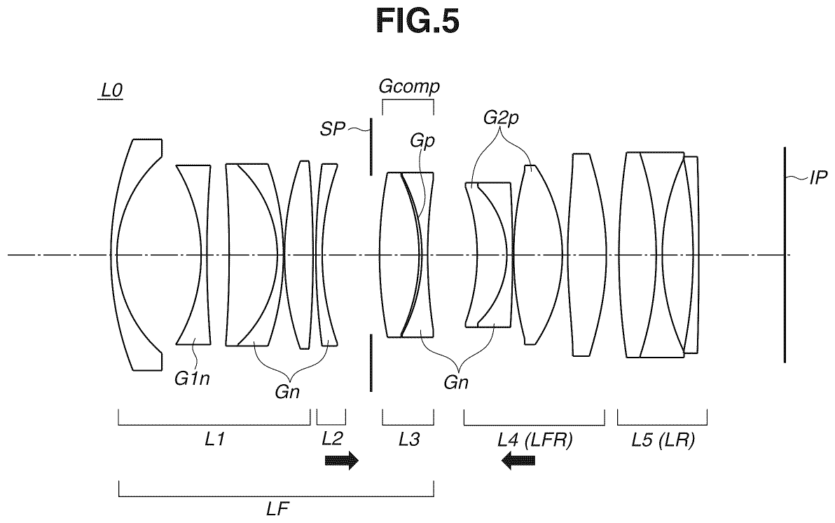

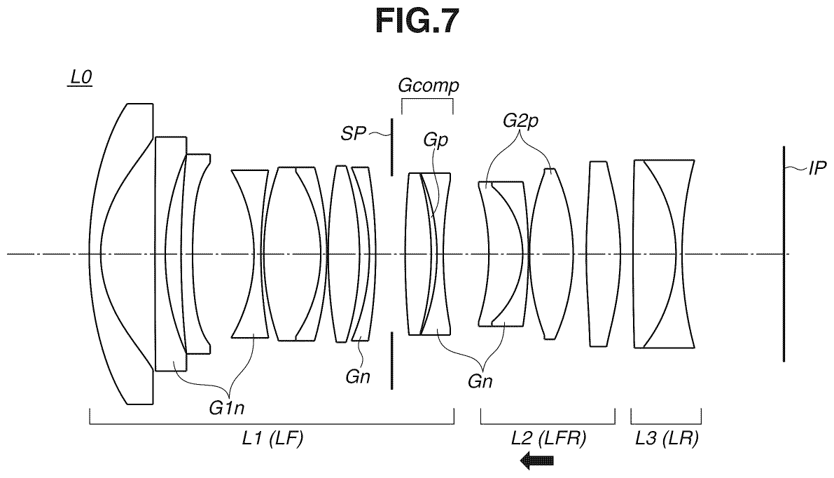

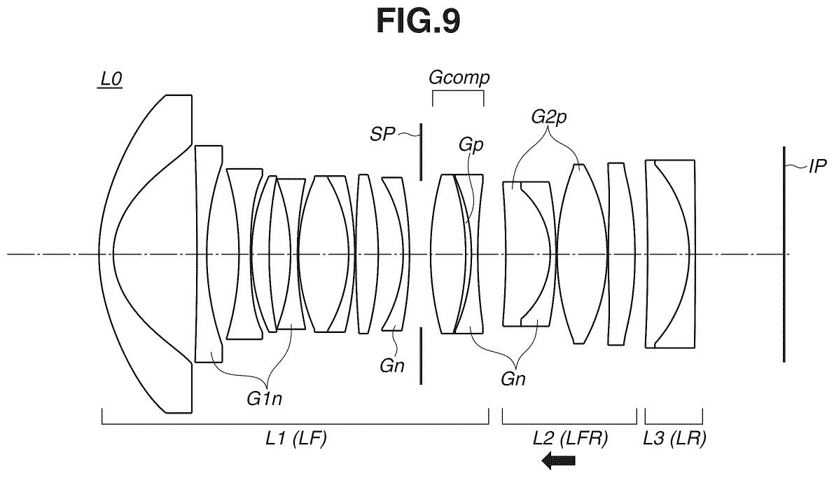

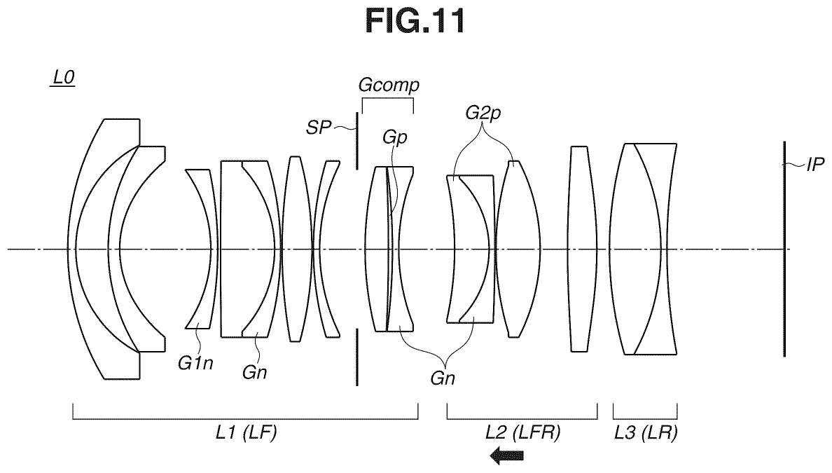

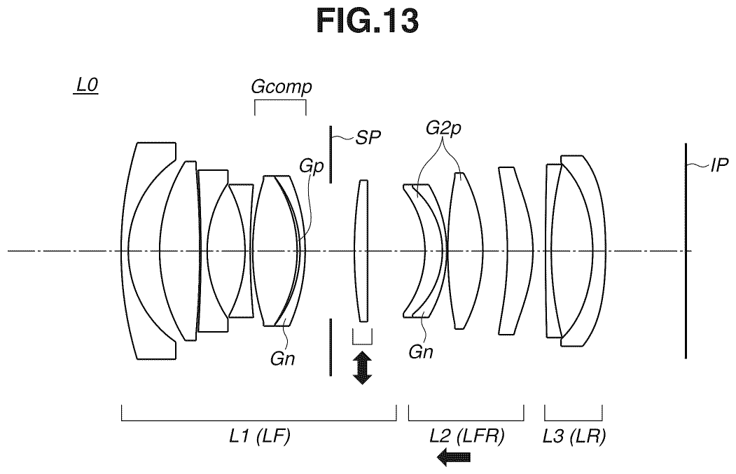

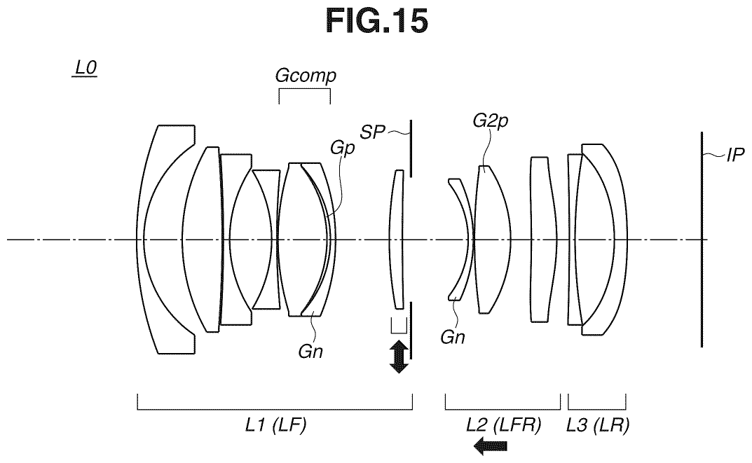

FIGS. 1, 3, 5, 7, 9, 11, 13, and 15 are cross-sectional views illustrating optical systems according to first to eighth embodiments that are at infinity focus.

In each cross-sectional view, the left side is an object side, and the right side is an image side. The optical systems according to the embodiments are suitable for use in imaging apparatuses, such as a digital video camera, a digital still camera, a broadcasting camera, a silver-halide film camera, a monitoring camera, or an in-vehicle camera. It should be noted that the optical systems according to the embodiments may be used as projection lenses of projectors. In this case, the left side is a screen side, and the right side is a projected image side.

In each cross-sectional view, an optical system L0 represents the entire optical system, and a lens unit Li represents the i-th lens unit (where i is a natural number), counted from the object side, of lens units configured to move integrally or be fixed with respect to an image plane during focusing. In other words, an air gap between adjacent lens units changes during focusing, and an air gap between lenses in each lens unit does not change during focusing. Further, each lens unit may consist of a single lens or a plurality of lenses.

It should be noted that the interior of a lens unit according to the present disclosure refers to a space between a lens of the lens unit that is arranged closest to the object side and another lens of the lens unit that is arranged closest to the image side.

Further, in the optical system L0, an image-side focusing unit LFR (a first focusing unit) refers to an image-side focusing unit that is a lens unit configured to move during focusing from infinity to a close distance and arranged closest to the image side. A front lens unit LF refers to a unit of lenses that are all arranged on the object side of the image-side focusing unit LFR. A rear lens unit LR refers to a unit of lenses that are all arranged on the image side of the image-side focusing unit LFR.

Further, at least some of the lenses included in the front lens unit LF may move as a front-side focusing unit in an optical axis direction during focusing.

Further, a lens Gk refers to the k-th lens (where k is a natural number), counted from the object side, of the optical system L0. Further, a lens surface of each lens may include a metasurface.

In each cross-sectional view, an arrow parallel to an optical axis indicates a moving direction of a lens unit during focusing from infinity to a close distance. According to each embodiment, the image-side focusing unit LFR, which will be described below, moves from the image side to the object side during focusing from infinity to a close distance.

In each cross-sectional view, an aperture stop SP represents an aperture stop that determines the light flux at the maximum aperture. An image plane IP represents an image plane where an imaging surface of a solid-state image sensor, such as a charge-coupled device (CCD) sensor or a complementary metal-oxide-semiconductor (CMOS) sensor, or a photoelectric conversion element is arranged in a case where the optical system according to each embodiment is used as an imaging optical system of a digital still camera or a digital video camera. It should be noted that the optical system according to each embodiment may be used as an imaging optical system of a silver-halide film camera. In this case, a photosensitive surface corresponding to a film surface is arranged on the image plane IP.

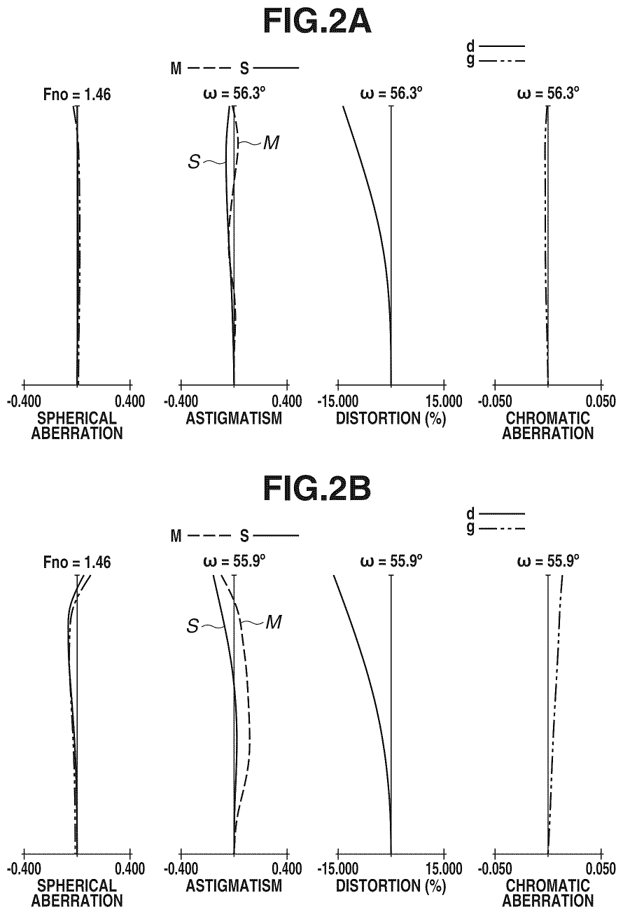

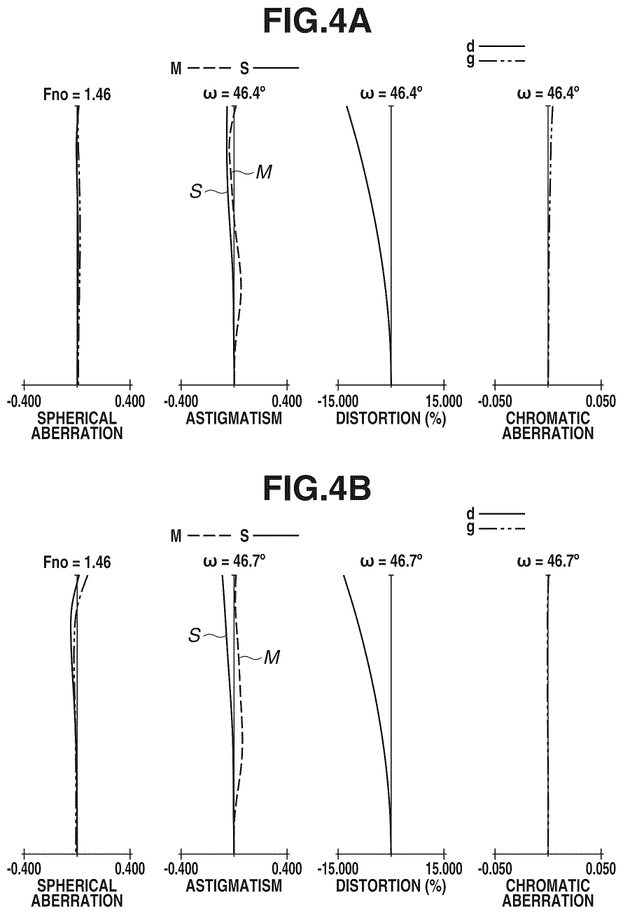

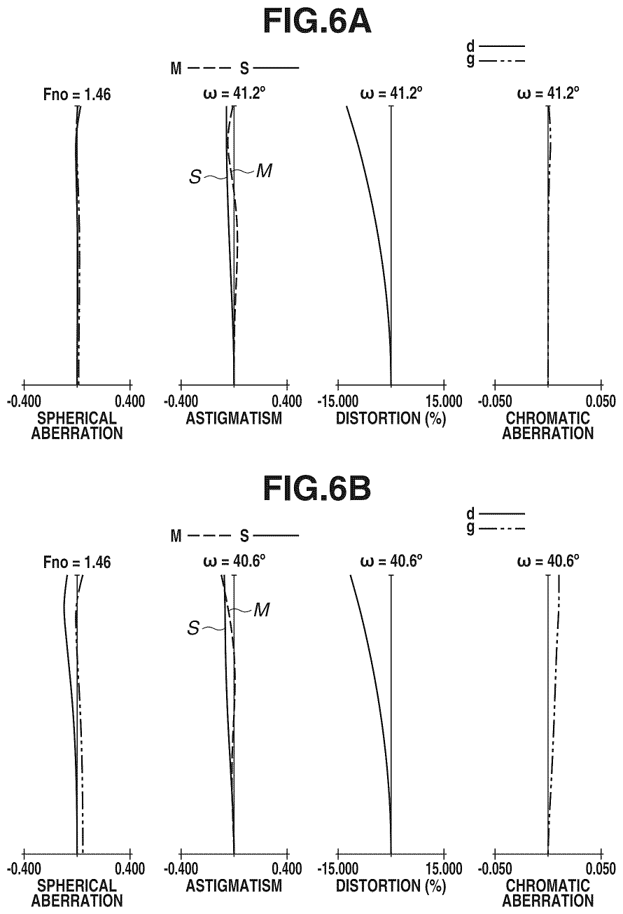

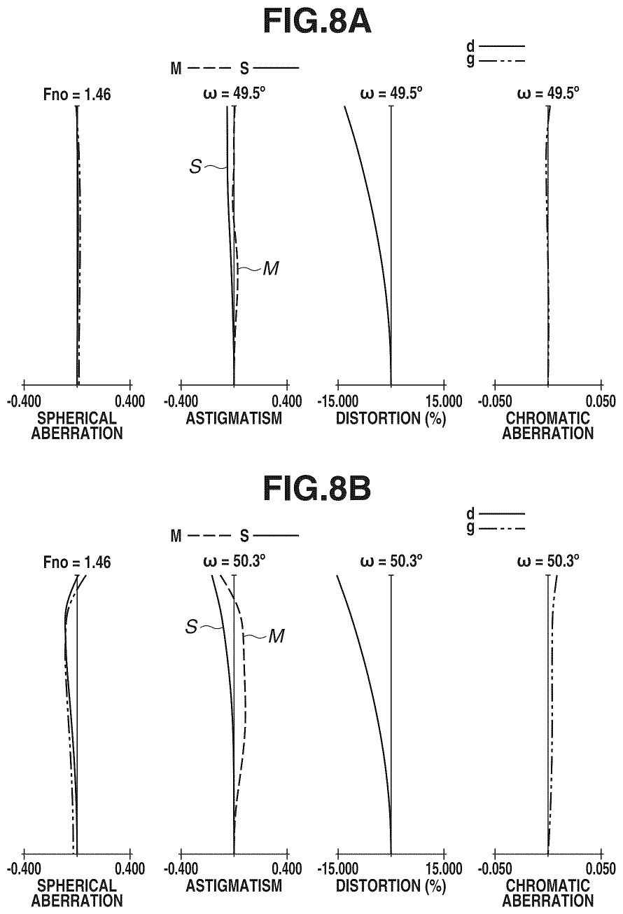

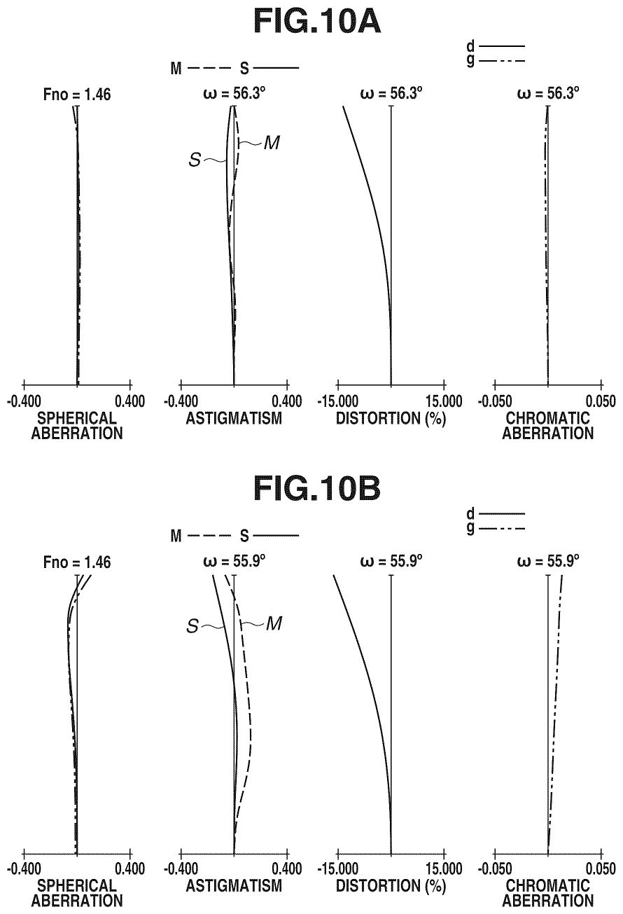

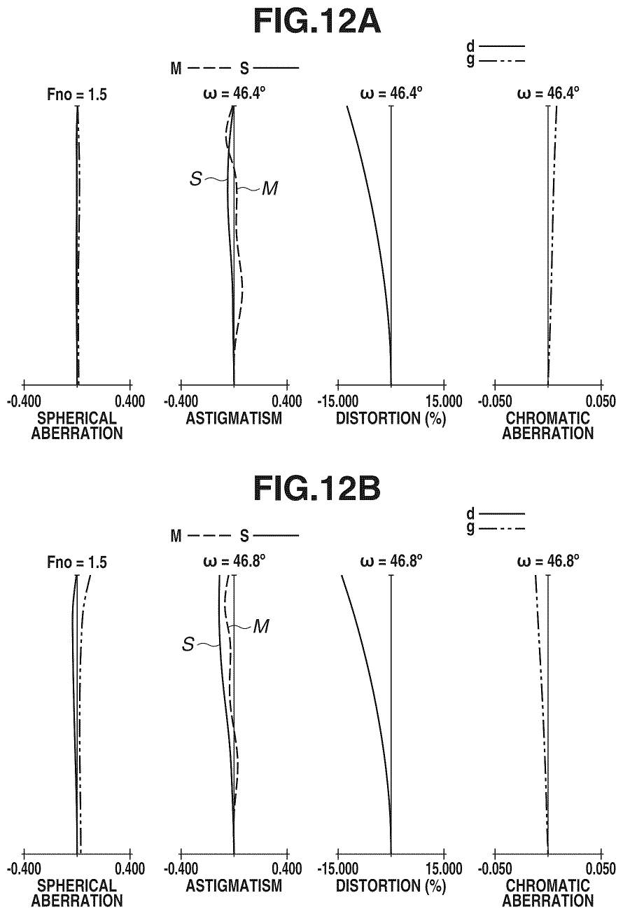

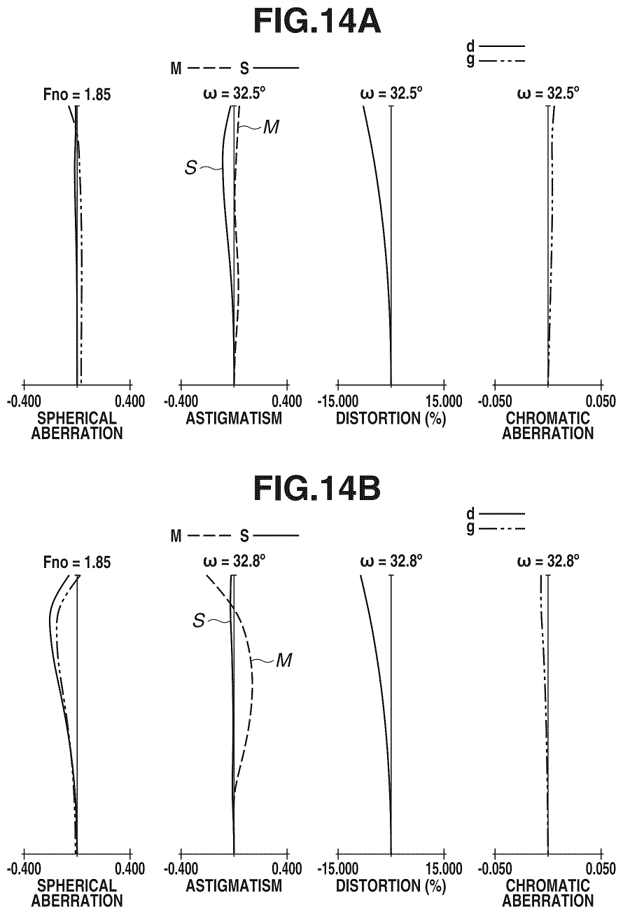

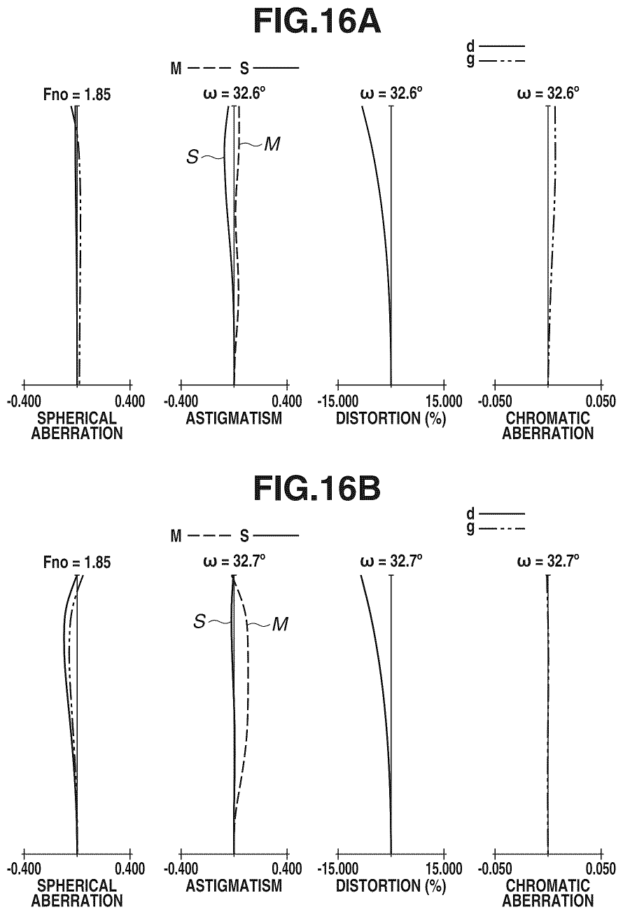

FIGS. 2A, 4A, 6A, 8A, 10A, 12A, 14A, and 16A are aberration diagrams illustrating the optical systems L0 according to the first to eighth embodiments that are at infinity focus, and FIGS. 2B, 4B, 6B, 8B, 10B, 12B, 14B, and 16B are aberration diagrams illustrating the optical systems L0 according to the first to eighth embodiments that are focused at a distance corresponding to a lateral magnification of −0.1.

In each spherical aberration diagram, Fno represents an f-number, a solid line represents the amount of spherical aberration with respect to the d-line (wavelength: 587.6 nm), and a double-dotted chain line represents the amount of spherical aberration with respect to the g-line (wavelength: 435.8 nm). In each astigmatism diagram, a solid line S represents the amount of aberration in a sagittal image plane, and a dashed line M represents the amount of aberration in a meridional image plane. In each distortion diagram, a solid line represents the amount of distortion with respect to the d-line. In each chromatic aberration diagram, a double-dotted chain line represents the amount of magnification chromatic aberration at the g-line. Further, @ represents an imaging half angle of view (°).

Next, a characteristic configuration of the optical system according to each embodiment will be described.

In an optical system described in Japanese Patent Laid-Open No. 2019-152773, a second lens unit configured to move during focusing has a large mass, which makes it difficult to achieve high-speed focusing. Further, optical performance may degrade during focusing.

On the other hand, the optical system L0 according to each embodiment consists of the front lens unit LF having positive refractive power, the image-side focusing unit LFR having positive refractive power, and the rear lens unit LR, arranged in order from the object side to the image side. During focusing from infinity to a close distance, the image-side focusing unit LFR moves with respect to the image plane to change the space between the front lens unit LF and the image-side focusing unit LFR and the space between the image-side focusing unit LFR and the rear lens unit LR.

The optical system L0 is configured so that a light beam converged by the front lens unit LF having positive refractive power enters the image-side focusing unit LFR having positive refractive power. This enables a reduction in lens diameter of the image-side focusing unit LFR, which moves with respect to the image plane during focusing, and a reduction in weight of the image-side focusing unit LFR, thereby making it possible to achieve high-speed focusing.

Further, the rear lens unit LR is arranged at a position distant from the aperture stop SP so that on-axis light and peripheral light are sufficiently separated in a direction orthogonal to the optical axis, thereby making it possible to effectively correct astigmatism and distortion and improvement in peripheral performance of the optical system L0.

Next, configurations that can be satisfied by the optical system L0 according to each embodiment will be described.

In the optical system L0 according to each embodiment, the aperture stop SP can be arranged either within the front lens unit LF or adjacent to the image side of the front lens unit LF. This enables a reduction in height of the off-axis light incident on the image-side focusing unit LFR and a reduction in the lens diameter of the image-side focusing unit LFR. Furthermore, the aperture stop SP is configured to remain stationary during focusing, thereby making it unnecessary to move a mechanical component or the like that constitutes the aperture stop SP during focusing. This enables a reduction in the weight of the image-side focusing unit LFR, thereby making it possible to achieve high-speed focusing.

In the optical system L0 according to each embodiment, the front lens unit LF can include at least two negative lenses. A wide-angle lens has strong negative refractive power on the object side of the optical system L0 to ensure sufficient back focus. By distributing this strong negative refractive power across at least two negative lenses, the refractive power per negative lens can be reduced, thereby enabling a reduction of distortion and field curvature.

In the optical system L0 according to each embodiment, the image-side focusing unit LFR can include at least two positive lenses and at least one negative lens. To reduce the amount of movement of the image-side focusing unit LFR during focusing from infinity to a close distance, in one embodiment, the refractive power of the image-side focusing unit LFR is increased. By distributing this strong refractive power across at least two positive lenses, the refractive power per positive lens can be reduced, thereby reducing variations in spherical aberration and field curvature during focusing. Further, including at least one negative lens enables a reduction in variations in axial chromatic aberration that occur during focusing.

In the optical system L0 according to each embodiment, an object-side lens surface of a lens arranged closest to the object side within the image-side focusing unit LFR can be concave toward the object side. This causes the off-axis light after passing through the aperture stop SP to be incident substantially concentrically on a surface closest to the object side within the image-side focusing unit LFR, thereby reducing the refraction of the light at the surface. This enables a reduction in variations in astigmatism, comatic aberration, and angle of view during focusing.

In the optical system L0 according to each embodiment, an image-side lens surface of a lens arranged closest to the image side within the image-side focusing unit LFR can have a convex shape toward the image side. This causes the off-axis light to exit the image-side focusing unit LFR substantially concentrically with respect to a surface closest to the image side within the image-side focusing unit LFR, thereby reducing the refraction of the light at the surface. This facilitates reduction in variations in astigmatism, comatic aberration, and angle of view during focusing.

In the optical system L0 according to each embodiment, a negative lens can be arranged closest to the image side within the rear lens unit LR, i.e., closest to the image side within the optical system L0. This enables an increase in the angle of the off-axis light incident on the image plane with respect to the optical axis, thereby enabling a reduction in lens diameter of the rear lens unit LR. Further, by arranging a negative lens at a position corresponding to a large off-axis ray height on the image side, the positive Petzval sum of the entire optical system L0 can be reduced without increasing sagittal flare, thereby making it possible to effectively correct field curvature.

In the optical system L0 according to each embodiment, a positive lens Gp can be arranged as a cemented lens Gcomp consisting of a positive lens, the positive lens Gp, and a negative lens, arranged in order from the object side, or as a cemented lens Gcomp consisting of a negative lens, the positive lens Gp, and a positive lens, arranged in order from the object side. This enhances the effect of axial chromatic aberration correction.

Further, in the optical system L0 according to each embodiment, each of object-side and image-side lens surfaces of the positive lens Gp is joined to another lens, thereby reducing the moisture absorption level of the positive lens Gp in a case where the positive lens Gp is made from a resin material. This enables a reduction in deformation of the positive lens Gp and the lenses joined to the positive lens Gp, thereby enabling a reduction in variations in spherical aberration and the like even in a high-humidity environment.

Next, conditions that can be satisfied by the optical system L0 according to each embodiment will be described.

The optical system L0 according to each embodiment can satisfy one or more of the following inequalities (1) to (18). It should be noted that various numerical values in the inequalities are expressed as follows.

The Abbe number of the material of the positive lens Gp included in the front lens unit LF is denoted by νdp, the partial dispersion ratio is denoted by θgFp, and the anomalous partial dispersibility is denoted by ΔθgFp. It should be noted that various numerical values are expressed as follows:

$$Δθ gFp = θ gFp - ( B 3 \times {vdp}^{3} + B 2 \times {vdp}^{2} + B 1 \times vdp + B 0 ) ;$$

$$B 3 = - 1.665 \times 1 {0}^{- 7} ;$$

$$B 2 = 5. 213 \times 1 {0}^{- 5} ;$$

$$B 1 = - 5.656 \times 1 {0}^{- 3} ;$$

$$and$$

$$B 0 = 7.278 \times 1 {0}^{- 1} .$$

The air-equivalent back focus of the optical system L0 at infinity focus is denoted by sk.

The focal length of the entire optical system L0 is denoted by f.

The focal length of the front lens unit LF is denoted by fLF. The focal length of the image-side focusing unit LFR is denoted by fLFR. The focal length of the rear lens unit LR is denoted by fLR.

The radius of curvature of a lens surface closest to the object side within the image-side focusing unit LFR is denoted by RLFR1, and the radius of curvature of a lens surface closest to the image side within the image-side focusing unit LFR is denoted by RLFR2.

The refractive index at the d-line of a material of a negative lens Gn included in the optical system L0 is denoted by Ndn.

The anomalous partial dispersibility ΔθgFn of the material of the negative lens Gn included in the optical system L0 is expressed as:

$$Δθ gFn = θ gFn - ( - 0.00251 \; 16 \times vdn + 0.67449 ) ,$$

where νdn denotes the Abbe number, and θgFn denotes the partial dispersion ratio with respect to the g-line and the F-line.

The lateral magnification of the image-side focusing unit LFR at infinity focus is denoted by βLFR, and the lateral magnification of the rear lens unit LR at infinity focus is denoted by βLR.

The total air gap along the optical axis from a surface closest to the object side to a surface closest to the image side within the optical system L0 is denoted by ΣDair.

The total optical length of the optical system L0 is denoted by L. The total optical length refers to a value obtained by adding the air-equivalent back focus to the distance from a first lens surface to a final lens surface.

The Abbe number of a material of a negative lens Gln included in the front lens unit LF is denoted by νd1n.

The Abbe number of a material of a positive lens G2p included in the image-side focusing unit LFR is denoted by νd2p.

The amount of movement of the image-side focusing unit LFR during focusing from infinity to an object distance corresponding to a lateral magnification of −0.1 in the entire system is denoted by MLFR.

The space along the optical axis from the aperture stop SP to an image-side lens surface of a lens arranged closest to the image side within the optical system L0 at infinity focus is denoted by DSP.

The focal length of the compound lens Gcomp included in the front lens unit LF and including the positive lens Gp is denoted by fGcomp.

$$0.05 < Δθ gFp < 0 \text{.250} \qquad ( 1 )$$

$$0.1 < sk / f < 1.80 \qquad ( 2 )$$

$$0.3 < fLF / fLFR < 3. \qquad ( 3 )$$

$$- 1.5 \; 0 < f / fLR < 1.50 \qquad ( 4 )$$

$$- 1.5 \; 0 < ( RLFR 2 - RLFR 1 ) / ( RLFR 2 + RLFR 1 ) < 1.5 \qquad ( 5 )$$

$$- 0.015 < Δθ gFn < 0 \text{.015} \qquad ( 6 )$$

$$- 0.2 < Ndn - ( - 1.454 \times 1 {0}^{- 2} \times vdn + 2.287 ) < 0.05 \qquad ( 7 )$$

$$0.5 < ( 1 - β {LFR}^{2} ) \times β {LR}^{2} < 2.50 \qquad ( 8 )$$

$$0. < sk / \vert fLR \vert < 0. 80 \qquad ( 9 )$$

$$0.2 < \sum Dair / ( L - sk ) < 0.70 \qquad ( 10 )$$

$$1.5 < L / f < 15 \text{.00} \qquad ( 11 )$$

$$60. < vd 2 p < 100.00 \qquad ( 12 )$$

$$- 0.2 < MLFR / DSP < - 0.0 \; 05 \qquad ( 13 )$$

$$60. < vd 1 n < 100. \qquad ( 14 )$$

$$0.5 < fLFR / f < 3.00 \qquad ( 15 )$$

$$0.3 < ( DSP + sk ) / L < 0 \text{.80} \qquad ( 16 )$$

$$0.5 < fLF / f < 5.00 \qquad ( 17 )$$

$$0. < f / fGcomp < 2. \qquad ( 18 )$$

Next, the technical meanings of the foregoing inequalities (1) to (18) will be explained.

The inequality (1) defines the anomalous partial dispersibility ΔθgFp of the positive lens Gp arranged in the front lens unit LF.

In large-aperture lenses, axial chromatic aberrations at short wavelengths, such as the g-line, often arise as issues. Especially primary achromatism for the C-line and F-line often results in excessive axial chromatic aberration at the g-line. Accordingly, a material with a high anomalous partial dispersibility ΔθgFp may be used in the positive lens to selectively converge excessive axial chromatic aberration at short wavelengths, such as the g-line, thereby making it possible to effectively correct axial chromatic aberration.

In a case where the anomalous partial dispersibility ΔθgFp decreases so that the lower limit of the inequality (1) is no longer met, it becomes difficult to correct axial chromatic aberration. Accordingly, this should be avoided.

In a case where the anomalous partial dispersibility ΔθgFp increases so that the upper limit of the inequality (1) is no longer met, excessive correction of axial chromatic aberration occurs. Accordingly, this should be avoided.

The inequality (2) relates to the air-equivalent back focus sk of the optical system L0. In a case where the inequality (2) is satisfied, the rear lens unit LR can be arranged at a position corresponding to a large off-axis ray height, thereby enabling selective correction of distortion and astigmatism while minimizing the impact on spherical aberration correction and sagittal flare correction. This enables improved peripheral performance of the optical system L0.

In a case where the back focus sk decreases so that the lower limit of the inequality (2) is no longer met, it becomes difficult to arrange a lens in the rear lens unit LR due to interference between the optical system L0 and a member, such as a camera, to which the optical system L0 is attached. Accordingly, this should be avoided.

In a case where the back focus sk increases so that the upper limit of the inequality (2) is no longer met, it becomes difficult to correct distortion, field curvature, and astigmatism. Accordingly, this should be avoided.

The inequality (3) defines the ratio of the refractive power of the front lens unit LF to the refractive power of the image-side focusing unit LFR.

In a case where the value of fLFR increases so that the lower limit of the inequality (3) is no longer met, the positive refractive power of the image-side focusing unit LFR becomes excessively low, which leads to an increased amount of movement of the lens unit during focusing and an increased total length of the optical system L0. Accordingly, this should be avoided. Further, in a case where the value of fLF decreases so that the lower limit of the inequality (3) is no longer met, it becomes difficult to correct spherical aberration and axial chromatic aberration. Accordingly, this should be avoided.

In a case where the value of fLFR decreases so that the upper limit of the inequality (3) is no longer met, the refractive power of the image-side focusing unit LFR becomes excessively high, which leads to an excessive change in performance, such as variations in spherical aberration, field curvature, and angle of view, during focusing. Accordingly, this should be avoided. Further, in a case where the value of fLF increases so that the upper limit of the inequality (3) is no longer met, the total length of the optical system L0 increases. Accordingly, this should be avoided.

The inequality (4) defines the ratio of the focal length f of the entire optical system L0 to the focal length fLR of the rear lens unit LR. The value of fLR is negative in the vicinity of the lower limit of the inequality (4). In a case where the absolute value of fLR decreases so that the lower limit of the inequality (4) is no longer met, the negative refractive power of the rear lens unit LR becomes excessively high, which leads to an excessively large incident angle of off-axis light at the image plane, often resulting in color unevenness when imaging with a solid-state image sensor, such as a CMOS sensor. Accordingly, this should be avoided.

The value of fLR is positive in the vicinity of the upper limit of the inequality (4). In a case where the absolute value of fLR decreases so that the upper limit of the inequality (4) is no longer met, the positive refractive power of the rear lens unit LR becomes excessively high, which leads to an excessively large positive Petzval sum across the entire optical system L0, making field curvature correction difficult. Accordingly, this should be avoided.

The inequality (5) defines the shape of the image-side focusing unit LFR and relates to a condition for reducing aberration and angle-of-view variations that occur during focusing.

In a case where the lower limit of the inequality (5) is not met, the absolute value of the radius of curvature of a concave surface closest to the object side within the image-side focusing unit LFR increases. In this case, the surface closest to the object side within the image-side focusing unit LFR becomes less concentric with respect to off-axis light entering the image-side focusing unit LFR. Further, the absolute value of the radius of curvature of a convex surface closest to the image side within the image-side focusing unit LFR decreases, which leads to a large refraction of off-axis light at the surface closest to the image side within the image-side focusing unit LFR. As a result, significant variations in angle of view often occur during focusing. Accordingly, this should be avoided.

In a case where the upper limit of the inequality (5) is not met, the absolute value of the radius of curvature of the concave surface closest to the object side within the image-side focusing unit LFR decreases. In this case, the surface closest to the object side within the image-side focusing unit LFR becomes less concentric with respect to off-axis light entering the image-side focusing unit LFR. As a result, significant variations in angle of view often occur during focusing. Further, the absolute value of the radius of curvature of convex surface closest to the image side within the image-side focusing unit LFR increases. Significant variations in aberrations, such as comatic aberration and astigmatism, often occur during focusing. Accordingly, this should be avoided.

The inequality (6) defines the anomalous partial dispersibility of the negative lens Gn of at least one of the front lens unit LF and the image-side focusing unit LFR.

In a case where the lower limit of the inequality (6) is not met, axial chromatic aberration correction for the g-line becomes excessive. Accordingly, this should be avoided.

In a case where the upper limit of the inequality (6) is not met, axial chromatic aberration correction for the g-line becomes insufficient. Accordingly, this should be avoided.

The inequality (7) defines the material dispersion of the negative lens Gn of at least one of the front lens unit LF and the image-side focusing unit LFR.

In a case where the lower limit of the inequality (7) is not met, the Abbe number of the negative lens Gn becomes excessively high. As a result, axial chromatic aberration correction becomes excessive. Accordingly, this should be avoided.

In a case where the upper limit of the inequality (7) is not met, the Abbe number of the negative lens Gn becomes excessively low. As a result, axial chromatic aberration correction becomes insufficient. Accordingly, this should be avoided. Further, the refractive power of the negative lens Gn becomes excessively high, and it becomes difficult to correct spherical aberration. Accordingly, this should be avoided.

In large-aperture lenses, axial chromatic aberrations at short wavelengths, such as the g-line, often arise as issues. Especially primary achromatism for the C-line and F-line often results in excessive axial chromatic aberration at the g-line. Accordingly, a material that satisfies the inequalities (6) and (7) may be used in the negative lens Gn to relatively reduce the divergence of the g-line caused by the negative lens, thereby reducing excessive axial chromatic aberrations at short wavelengths, such as the g-line.

By arranging at least one negative lens Gn that satisfies both inequalities (6) and (7) in at least one of the front lens unit LF and the image-side focusing unit LFR, the above-described effect of axial chromatic aberration correction is achieved.

Further, including two negative lenses Gn in at least one of the front lens unit LF and the image-side focusing unit LFR enhances the above-described effect of axial chromatic aberration correction. Further, including three or more negative lenses Gn further enhances the above-described effect of axial chromatic aberration correction.

Furthermore, at least one or more negative lenses Gn can be arranged in each of the front lens unit LF and the image-side focusing unit LFR. Arranging the negative lens Gn in the front lens unit LF enables effective correction of axial chromatic aberration across the entire optical system L0. Arranging the negative lens Gn in the image-side focusing unit LFR facilitates axial chromatic aberration correction within the image-side focusing unit LFR, thereby reducing variations in axial chromatic aberration during focusing.

The inequality (8) defines the position sensitivity of the image-side focusing unit LFR, i.e., the ratio of the amount of movement of the image plane to the amount of movement of the image-side focusing unit LFR during focusing.

In a case where the lower limit of the inequality (8) is not met, the position sensitivity of the image-side focusing unit LFR becomes excessively low.

As a result, the distance over which focusing is achievable increases. Accordingly, this should be avoided. Further, since an air gap through which focusing can be achieved is ensured, it becomes difficult to reduce the total length of the optical system L0. Accordingly, this should be avoided.

In a case where the upper limit of the inequality (8) is not met, the refractive power of the image-side focusing unit LFR becomes excessively high, which leads to an excessive change in performance, such as a variation in spherical aberration, field curvature, or angle of view, during focusing. Accordingly, this should be avoided.

The inequality (9) defines the ratio of the air-equivalent back focus sk to the focal length fLR of the rear lens unit LR.

In a case where the air-equivalent back focus sk decreases so that the lower limit of the inequality (9) is no longer met, the image plane of the optical system L0 is arranged either at a position closer to the object side than a lens surface closest to the image side within the rear lens unit LR is or at a position corresponding to the lens surface closest to the image side, which makes it difficult to capture an image. Accordingly, this should be avoided.

In a case where the air-equivalent back focus sk increases so that the upper limit of the inequality (9) is no longer met, the absolute value of the refractive power of the rear lens unit LR becomes excessively high. In a case where the negative refractive power of the rear lens unit LR becomes excessively high, the incident angle of off-axis light at the image plane becomes excessively large, often resulting in color unevenness when imaging with an image sensor, such as a CMOS sensor. Accordingly, this should be avoided. In a case where the positive refractive power of the rear lens unit LR becomes excessively high, the positive Petzval sum across the entire optical system L0 becomes excessively large, making field curvature correction difficult. Accordingly, this should be avoided.

The inequality (10) defines the ratio of the total air gap ΣDair along the optical axis from the surface closest to the object side to the surface closest to the image side within the optical system L0 to the total optical length L of the optical system L0.

In a case where the total air gap ΣDair decreases so that the lower limit of the inequality (10) is no longer met, it becomes difficult to ensure sufficient space for movement of the lens unit during focusing. Further, to provide a negative lens included in a first lens unit with sufficient positive curvature, an air gap between the negative lens and an adjacent lens along the optical axis is included. However, this becomes difficult. As a result, it becomes difficult to configure the optical system L0 as a wide-angle optical system and to correct distortion. Accordingly, this should be avoided.

In a case where the total air gap ΣDair increases so that the upper limit of the inequality (10) is no longer met, the ratio of the air gap to the total optical length becomes excessively high, which makes it difficult to provide each positive lens with sufficient refractive power, making it difficult to correct spherical aberration and axial chromatic aberration. Accordingly, this should be avoided. Further, providing each positive lens with sufficient refractive power results in an increased total length. Accordingly, this should be avoided.

The inequality (11) defines the ratio of the total optical length L of the optical system L0 to the focal length f of the entire optical system L0.

In a case where the total optical length L decreases so that the lower limit of the inequality (11) is no longer met, the refractive power of each lens unit becomes excessively high, and it becomes difficult to correct aberrations, such as distortion, astigmatism, and spherical aberration. Accordingly, this should be avoided.

In a case where the total optical length L increases so that the upper limit of the inequality (11) is no longer met, the total length of the optical system L0 increases. Accordingly, this should be avoided.

The inequality (12) defines the Abbe number νd2p of a material of at least one positive lens G2p included in the image-side focusing unit LFR, defining a condition for effective correction of axial chromatic aberration.

In a case where the Abbe number νd2p decreases so that the lower limit of the inequality (12) is no longer met, it becomes difficult to correct axial chromatic aberration. Accordingly, this should be avoided.

In a case where the Abbe number νd2p increases so that the upper limit of the inequality (12) is no longer met, magnification chromatic aberration correction becomes excessive. Accordingly, this should be avoided.

It should be noted that two or more positive lenses G2p that satisfy the inequality (12) can be arranged in the image-side focusing unit LFR to enhance the above-described effect.

The inequality (13) defines the ratio of the amount of movement MLFR of the image-side focusing unit LFR during focusing from infinity to an object distance at which the lateral magnification of the entire system is −0.1 to the space DSP along the optical axis from the aperture stop SP to the surface closest to the image side. It should be noted that the sign of the amount of movement MLFR from the object side to the image side is defined as positive.

In a case where the lower limit of the inequality (13) is not met, the refractive power of the image-side focusing unit LFR becomes excessively high, and variations in spherical aberration and field curvature during focusing increase. Accordingly, this should be avoided.

In a case where the amount of movement MLFR increases so that the upper limit of the inequality (13) is no longer met, the amount of movement of the image-side focusing unit LFR increases, and to ensure space for the movement, the total length increases. Accordingly, this should be avoided.

The inequality (14) defines the Abbe number νd1n of a material of the negative lens Gln included in the front lens unit LF, defining a condition for effective correction of magnification chromatic aberration.

In a case where the Abbe number νd1n decreases so that the lower limit of the inequality (14) is no longer met, it becomes difficult to correct magnification chromatic aberration. Accordingly, this should be avoided.

In a case where the Abbe number νd1n increases so that the upper limit of the inequality (14) is no longer met, magnification chromatic aberration correction becomes excessive, and the degree of abrasion on the negative lens Gn1 becomes excessive, which makes processing difficult and makes the negative lens Gn1 more prone to cracking. Accordingly, this should be avoided.

It should be noted that two or more negative lenses Gln that satisfy the inequality (14) can be arranged in the front lens unit LF to enhance the above-described effect.

The inequality (15) relates to the refractive power of the image-side focusing unit LFR. By satisfying the inequality (15), the focal length fLFR of the image-side focusing unit LFR decreases, and the object distance at which focus is achievable can be brought closer to the image plane by focusing. Further, the total length of the optical system L0 can be reduced while reducing changes in optical performance during focusing.

In a case where the focal length fLFR of the positive image-side focusing unit LFR decreases so that the lower limit of the inequality (15) is no longer met, the refractive power of the image-side focusing unit LFR becomes excessively high. As a result, an excessive change in performance, such as a variation in spherical aberration, field curvature, or angle of view, may occur during focusing. Accordingly, this should be avoided.

In a case where the focal length fLFR of the positive image-side focusing unit LFR increases so that the upper limit of the inequality (15) is no longer met, the position sensitivity of the image-side focusing unit LFR, i.e., the ratio of the amount of movement of the image plane to the amount of movement of the focusing unit, becomes excessively small. As a result, the object distance at which focus is achievable is moved farther from the image plane by focusing. Accordingly, this should be avoided. Further, the total length of the optical system L0 increases to ensure an air gap through which focusing can be achieved. Accordingly, this should be avoided.

Further, the negative lens Gn that satisfies the inequalities (6) and (7) can be used as the negative lens constituting the cemented lens Gcomp, thereby making it possible to effectively correct axial chromatic aberration.

Further, the cemented lens Gcomp can be arranged adjacent to the object or image side of the aperture stop SP arranged in the front lens unit LF. This results in the cemented lens Gcomp being arranged at a position corresponding to a large on-axis ray height, thereby enhancing the effect of axial chromatic aberration correction.

Further, the cemented lens Gcomp and the aperture stop SP can be arranged in the front lens unit LF configured to remain stationary during focusing. The cemented lens Gcomp can be arranged in front of or behind the aperture stop SP as described above. Since the on-axis beam diameter is large in front of and behind the aperture stop SP, the lens diameter and weight increase. Accordingly, the aperture stop SP and the cemented lens Gcomp including the positive lens Gp should be configured to remain stationary during focusing.

The inequality (16) defines the position DSP of the aperture stop SP, defining a condition for configuring the optical system L0 to be compact.

In a case where the position DSP decreases so that the lower limit of the inequality (16) is no longer met, the lens diameters of the lenses arranged closer to the object side than the aperture stop SP is increase, which leads to increased mass and diameter of the entire optical system L0. Accordingly, this should be avoided. Further, the incident angle of off-axis light at the image plane becomes excessively large, which often results in color unevenness when imaging with a solid-state image sensor, such as a CMOS sensor. Accordingly, this should be avoided.

In a case where the position DSP increases so that the upper limit of the inequality (16) is no longer met, the lens diameters of the lenses arranged closer to the image side than the aperture stop SP is increase, which leads to increased mass and diameter of the entire optical system L0. Accordingly, this should be avoided.

The inequality (17) defines the focal length fLF of the front lens unit LF.

In a case where the focal length fLF decreases so that the lower limit of the inequality (17) is no longer met, the positive refractive power of the front lens unit LF becomes excessively high, and it becomes difficult to correct spherical aberration and distortion. Accordingly, this should be avoided.

In a case where the focal length fLF increases so that the upper limit of the inequality (17) is no longer met, the lens diameter of the image-side focusing unit LFR increases. As a result, the mass of the image-side focusing unit LFR increases, and it becomes difficult to achieve high-speed focusing. Accordingly, this should be avoided.

The inequality (18) defines the focal length fGcomp of the compound lens Gcomp.

In a case where the focal length fGcomp has a negative value so that the lower limit of the inequality (18) is no longer met, it becomes difficult to correct axial chromatic aberration. Accordingly, this should be avoided.

In a case where the focal length fGcomp decreases so that the upper limit of the inequality (18) is no longer met, the positive refractive power of the compound lens Gcomp becomes excessively high, and axial chromatic aberration correction becomes excessive. Accordingly, this should be avoided.

It should be noted that the numerical ranges of the inequalities (1) to (18) can be set to the numerical ranges of the following inequalities (1a) to (18a):

$$0.06 < Δθ gFp < 0.22 ; \qquad ( 1 a )$$

$$0.2 < sk / f < 1.6 ; \qquad ( 2 a )$$

$$0.5 < fLF / fLFR < 2.7 ; \qquad ( 3 a )$$

$$- 1.2 < f / fLR < 1.2 ; \qquad ( 4 a )$$

$$- 1.2 < ( RLFR 2 - RLFR 1 ) / ( RLFR 2 + RLFR 1 ) < 1.2 ; \qquad ( 5 a )$$

$$- 0.01 < Δθ gFn < 0.01 ; \qquad ( 6 a )$$

$$- 0.18 < Ndn - ( - 1.454 \times 1 {0}^{- 2} \times vdn + 2.287 ) < 0.03 ; \qquad ( 7 a )$$

$$0.6 < ( 1 - β {LFR}^{2} ) \times β {LR}^{2} < 2.2 ; \qquad ( 8 a )$$

$$0. < sk / \vert fLR \vert < 0.7 ; \qquad ( 9 a )$$

$$0.25 < \sum Dair / ( L - sk ) < 0.64 ; \qquad ( 10 a )$$

$$2. < L / f < 13.5 ; \qquad ( 11 a )$$

$$62. < vd 2 p < 99. ; \qquad ( 12 a )$$

$$- 0.16 < MLFR / DSP < - 0.008 ; \qquad ( 13 a )$$

$$62. < vd 1 n < 99. ; \qquad ( 14 a )$$

$$0.7 < fLFR / f < 2.8 ; \qquad ( 15 a )$$

$$0.35 < ( DSP + sk ) / L < 0.74 ; \qquad ( 16 a )$$

$$0.7 < fLF / f < 4.5 ; \qquad ( 17 a )$$

$$and$$

$$0.01 < f / fGcomp < 1.8 . \qquad ( 18 a )$$

Further, the numerical ranges of the inequalities (1) to (18) can be set to the numerical ranges of the following inequalities (1b) to (18b):

$$0.07 < Δθ gFp < 0.19 ; \qquad ( 1 b )$$

$$0.3 < sk / f < 1.4 ; \qquad ( 2 b )$$

$$0.7 < fLF / fLFR < 2.3 ; \qquad ( 3 b )$$

$$- 0.9 < f / fLR < 0.5 ; \qquad ( 4 b )$$

$$- 0.8 < ( RLFR 2 - RLFR 1 ) / ( RLFR 2 + RLFR 1 ) < 0.8 ; \qquad ( 5 b )$$

$$- 0.008 < Δθ gFn < 0.007 ; \qquad ( 6 b )$$

$$- 0.15 < Ndn - ( - 1.454 \times 1 {0}^{- 2} \times vdn + 2.287 ) < 0.02 ; \qquad ( 7 b )$$

$$0.55 < ( 1 - β {LFR}^{2} ) \times β {LR}^{2} < 1.9 ; \qquad ( 8 b )$$

$$0. < sk / \vert fLR \vert < 0.6 ; \qquad ( 9 b )$$

$$0.3 < \sum Dair / ( L - sk ) < 0.59 ; \qquad ( 10 b )$$

$$2.2 < L / f < 12. ; \qquad ( 11 b )$$

$$64. < vd 2 p < 98. ; \qquad ( 12 b )$$

$$- 0.12 < MLFR / DSP < - 0.012 ; \qquad ( 13 b )$$

$$64. < vd 1 n < 98. ; \qquad ( 14 b )$$

$$0.9 < fLFR / f < 2.6 ; \qquad ( 15 b )$$

$$0.4 < ( DSP + sk ) / L < 0.68 ; \qquad ( 16 b )$$

$$1. < fLF / f < 4. ; \qquad ( 17 b )$$

$$and$$

$$0.02 < f / fGcomp < 1.6 . \qquad ( 18 b )$$

Further, the numerical ranges of the inequalities (1) to (18) can be set to the numerical ranges of the following inequalities (1c) to (18c):

$$0.08 < Δθ gFp < 0.16 ; \qquad ( 1 c )$$

$$0.38 < sk / f < 1.2 ; \qquad ( 2 c )$$

$$0.9 < fLF / fLFR < 1.8 ; \qquad ( 3 c )$$

$$- 0.7 < f / fLR < 0.2 ; \qquad ( 4 c )$$

$$- 0.5 < ( RLFR 2 - RLFR 1 ) / ( RLFR 2 + RLFR 1 ) < 0.5 ; \qquad ( 5 c )$$

$$- 0.006 < Δθ gFn < 0.004 ; \qquad ( 6 c )$$

$$- 0.13 < Ndn - ( - 0.0145425 \times vdn + 2 \text{.28725} ) < 0.01 ; \qquad ( 7 c )$$

$$0.65 < ( 1 - β {LFR}^{2} ) \times β {LR}^{2} < 1.6 ; \qquad ( 8 c )$$

$$0. < sk / \vert fLR \vert < 0.4 ; \qquad ( 9 c )$$

$$0.33 < \sum Dair / ( L - sk ) < 0.57 ; \qquad ( 10 c )$$

$$2.6 < L / f < 11. ; \qquad ( 11 c )$$

$$66. < vd 2 p < 97. ; \qquad ( 12 c )$$

$$- 0.08 < MLFR / DSP < - 0.016 ; \qquad ( 13 c )$$

$$66. < vd 1 n < 97. ; \qquad ( 14 c )$$

$$1. < fLFR / f < 2.4 ; \qquad ( 15 c )$$

$$0.45 < ( DSP + sk ) / L < 0.65 ; \qquad ( 16 c )$$

$$1.3 < fLF / f < 3.5 ; \qquad ( 17 c )$$

$$and$$

$$0.04 < f / fGcomp < 1.4 . \qquad ( 18 c )$$

Further, setting the lower limit of the inequality (1) to 0.10, 0.12, or 0.13 further enhances the effect associated with the lower limit of the inequality (1).

Furthermore, setting the upper limit of the inequality (1) to 0.155, 0.15, or 0.145 further enhances the effect associated with the upper limit of the inequality (1).

Further, setting the lower limit of the inequality (12) to 68.00, 70.00, 73.00, 75.00, or 80.00 further enhances the effect associated with the lower limit of the inequality (12).

Further, setting the upper limit of the inequality (18) to 1.20, 1.00, 0.80, 0.60, or 0.40 further enhances the effect associated with the upper limit of the inequality (18).

Next, detailed configurations of the optical systems L0 according to the first to eighth embodiments will be described. It should be noted that descriptions of configurations in the optical systems L0 according to the embodiments that are similar to those in the optical system L0 according to the first embodiment are omitted below, and mainly differences from the first embodiment will be described.

### First Embodiment

The optical system L0 according to the first embodiment consists of a first lens unit L1 having positive refractive power, a second lens unit L2 having positive refractive power, and a third lens unit L3 having negative refractive power.

In the optical system L0 according to the first embodiment, the front lens unit LF having positive refractive power corresponds to the first lens unit L1, the image-side focusing unit LFR having positive refractive power corresponds to the second lens unit L2, and the rear lens unit LR corresponds to the third lens unit L3.

By configuring the rear lens unit LR to have negative refractive power, it becomes easier to correct the positive Petzval sum, thereby making it possible to effectively correct field curvature.

In the optical system L0 according to the first embodiment, the front lens unit LF consists of lenses G1 to G12, the image-side focusing unit LFR consists of lenses G13 to G16, and the rear lens unit LR consists of lenses G17 and G18. The front lens unit LF includes seven negative lenses.

In the optical system L0 according to the first embodiment, the aperture stop SP is arranged within the front lens unit LF. Further, the lenses G1 and G3 are aspherical lenses, thereby making it possible to effectively correct distortion and astigmatism.

In the optical system L0 according to the first embodiment, a lens closest to the image side within the image-side focusing unit LFR is an aspherical lens. This makes it possible to effectively correct spherical aberration, field curvature, and astigmatism. Further, the aspherical lens is arranged closest to the image side within the image-side focusing unit LFR by which a light beam is converged, thereby reducing the rate of performance degradation due to deviations from an intended surface shape caused by fabrication error.

In the optical system L0 according to the first embodiment, the lenses G6 and G7 are assembled into a single compound lens, and the lenses G10 to G12 are assembled into a single compound lens. Further, the lenses G13 and G14 are assembled into a single compound lens, and the lenses G17 and G18 are assembled into a single compound lens.

In the optical system L0 according to the first embodiment, the lens G11 is the positive lens Gp with positive anomalous partial dispersibility, and the positive lens G10, the lens G11, and the negative lens G12 are assembled in order to form the cemented lens Gcomp. This makes it possible to effectively correct axial chromatic aberration at short wavelengths, such as the g-line.

Further, during focusing, the image-side focusing unit LFR moves in the optical axis direction from the image side to the object side with respect to the image plane, and the front lens unit LF and the rear lens unit LR remain stationary with respect to the image plane.

### Second Embodiment

In the optical system L0 according to a second embodiment, the front lens unit LF consists of the lenses G1 to G10, the image-side focusing unit LFR consists of the lenses G11 to G14, and the rear lens unit LR consists of the lenses G15 and G16.

In the optical system L0 according to the second embodiment, the lenses G4 and G5 are assembled into a single compound lens, and the lenses G8 to G10 are assembled into a single compound lens. Further, the lenses G11 and G12 are assembled into a single compound lens, and the lenses G15 and G16 are assembled into a single compound lens. The front lens unit LF includes six negative lenses.

In the optical system L0 according to the second embodiment, the lens G9 is the positive lens Gp with positive anomalous partial dispersibility, and the positive lens G8, the lens G9, and the negative lens G10 are assembled in order to form the cemented lens Gcomp. This makes it possible to effectively correct axial chromatic aberration at short wavelengths, such as the g-line.

### Third Embodiment

The optical system L0 according to a third embodiment consists of the first lens unit L1 having positive refractive power, the second lens unit L2 having negative refractive power, the third lens unit L3 having positive refractive power, a fourth lens unit LA having positive refractive power, and a fifth lens unit L5 having negative refractive power.

The front lens unit LF having positive refractive power consists of the first lens unit L1, the second lens unit L2, and the third lens unit L3. The image-side focusing unit LFR having positive refractive power corresponds to the fourth lens unit LA, and the rear lens unit LR corresponds to the fifth lens unit L5.

In the optical system L0 according to the third embodiment, the front lens unit LF consists of the lenses G1 to G8, the image-side focusing unit LFR consists of the lenses G9 to G12, and the rear lens unit LR consists of the lenses G13 to G15. The front lens unit LF includes five negative lenses. Further, the aperture stop SP is arranged within the front lens unit LF.

In the optical system L0 according to the third embodiment, the lenses G3 and G4 are assembled into a single compound lens, and the lenses G7 to G9 are assembled into a single compound lens. Further, the lenses G10 and G11 are assembled into a single compound lens, and the lenses G14 and G15 are assembled into a single compound lens.

In the optical system L0 according to the third embodiment, the lens G8 is the positive lens Gp with positive anomalous partial dispersibility, and the positive lens G7, the lens G8, and the negative lens G9 are assembled in order to form the cemented lens Gcomp. This makes it possible to effectively correct axial chromatic aberration at short wavelengths, such as the g-line.

In the optical system L0 according to the third embodiment, during focusing from infinity to a close distance, the second lens unit L2 moves from the object side to the image side, and the fourth lens unit LA moves from the image side to the object side. Since the second lens unit L2 moves during focusing in addition to the fourth lens unit L4, which corresponds to the image-side focusing unit LFR, variations in field curvature and focus breathing are reduced.

Further, in place of the second lens unit L2, another lens within the front lens unit LF may be moved from the object side to the image side, or from the image side to the object side. For example, the lens G5 may be moved from the image side to the object side to reduce variations in field curvature during focusing.

Further, during focusing from infinity to a close distance, the first lens unit L1, the third lens unit L3, and the fifth lens unit L5 remain stationary with respect to the image plane.

### Fourth Embodiment

In the optical system L0 according to a fourth embodiment, the front lens unit LF consists of the lenses G1 to G11, the image-side focusing unit LFR consists of the lenses G12 to G15, and the rear lens unit LR consists of the lenses G16 and G17. The front lens unit LF includes seven negative lenses.

In the optical system L0 according to the fourth embodiment, the lenses G5 and G6 are assembled into a single compound lens, and the lenses G9 to G11 are assembled into a single compound lens. Further, the lenses G12 and G13 are assembled into a single compound lens, and the lenses G16 and G17 are assembled into a single compound lens.

In the optical system L0 according to the fourth embodiment, the lens G10 is the positive lens Gp with positive anomalous partial dispersibility, and the positive lens G9, the lens G10, and the negative lens G11 are assembled in order to form the cemented lens Gcomp. This makes it possible to effectively correct axial chromatic aberration at short wavelengths, such as the g-line.

### Fifth Embodiment

In the optical system L0 according to a fifth embodiment, the front lens unit LF consists of the lenses G1 to G12, the image-side focusing unit LFR consists of the lenses G13 to G16, and the rear lens unit LR consists of the lenses G17 and G18. The front lens unit LF includes seven negative lenses. Further, the lenses G1 and G3 are aspherical lenses, thereby making it possible to effectively correct distortion and astigmatism.

In the optical system L0 according to the fifth embodiment, the lenses G6 and G7 are assembled into a single compound lens, and the lenses G10 to G12 are assembled into a single compound lens. Further, the lenses G13 and G14 are assembled into a single compound lens, and the lenses G17 and G18 are assembled into a single compound lens.

### Sixth Embodiment

The optical system L0 according to a sixth embodiment consists of the first lens unit L1 having positive refractive power, the second lens unit L2 having positive refractive power, and the third lens unit L3 having positive refractive power.

The front lens unit LF having positive refractive power corresponds to the first lens unit L1. The image-side focusing unit LFR having positive refractive power corresponds to the second lens unit L2. The rear lens unit LR corresponds to the third lens unit L3.

The optical system L0 according to the sixth embodiment consists of the front lens unit LF having positive refractive power, the image-side focusing unit LFR having positive refractive power, and the rear lens unit LR having positive refractive power. Since the rear lens unit LR is configured to have positive refractive power, the incident angle of off-axis light at the image plane is reduced, thereby facilitating reduction of color unevenness when imaging with a solid-state image sensor, such as a CMOS sensor.

In the optical system L0 according to the sixth embodiment, the front lens unit LF consists of the lenses G1 to G10, the image-side focusing unit LFR consists of the lenses G11 to G14, and the rear lens unit LR consists of the lenses G15 and G16. The front lens unit LF includes six negative lenses. Further, the lenses G1 and G3 are aspherical lenses, thereby making it possible to effectively correct distortion and astigmatism.

In the optical system L0 according to the sixth embodiment, the lenses G4 and G5 are assembled into a single compound lens, and the lenses G8 to G10 are assembled into a single compound lens. Further, the lenses G11 and G12 are assembled into a single compound lens, and the lenses G15 and G16 are assembled into a single compound lens.

In the optical system L0 according to the sixth embodiment, the lens G9 is the positive lens Gp with positive anomalous partial dispersibility, and the positive lens G8, the lens G9, and the negative lens G10 are assembled in order to form the cemented lens Gcomp. This makes it possible to effectively correct axial chromatic aberration at short wavelengths, such as the g-line.

### Seventh Embodiment

In the optical system L0 according to a seventh embodiment, the front lens unit LF consists of the lenses G1 to G8, the image-side focusing unit LFR consists of the lenses G9 to G12, and the rear lens unit LR consists of the lenses G13 and G14. Further, the lens G14 closest to the image side is an aspherical lens, thereby making it possible to effectively correct distortion and astigmatism.

Further, the lens G12 is made from a plastic resin, thereby enabling a reduction in the weight of the image-side focusing unit LFR and achieving high-speed focusing.

In the optical system L0 according to the seventh embodiment, the lenses G5 to G7 are assembled into a single compound lens, and the lenses G9 and G10 are assembled into a single compound lens. Further, the lenses G13 and G14 are assembled into a single compound lens.

In the optical system L0 according to the seventh embodiment, the lens G8 included in the front lens unit LF moves to include a component in the direction orthogonal to the optical axis. This makes it possible to correct image blur and reduce variations in comatic aberration and one-sided defocusing during image blur correction.

In the optical system L0 according to the seventh embodiment, a negative lens can be arranged closest to the image side within the rear lens unit LR, i.e., closest to the image side within the optical system L0. This enables an increase in the angle of the off-axis light incident on the image plane with respect to the optical axis, thereby enabling a reduction in lens diameter of the rear lens unit LR. Further, by arranging a negative lens at a position corresponding to a large off-axis ray height on the image side, the positive Petzval sum of the entire optical system L0 can be reduced without increasing sagittal flare, thereby making it possible to effectively correct field curvature.

### Eighth Embodiment

In the optical system L0 according to an eighth embodiment, the front lens unit LF consists of the lenses G1 to G8, the image-side focusing unit LFR consists of the lenses G9 to G11, and the rear lens unit LR consists of the lenses G12 and G13. The front lens unit LF includes four negative lenses.

In the optical system L0 according to the eighth embodiment, the lens G7 is the positive lens Gp with positive anomalous partial dispersibility, and the positive lens G6, the lens G7, and the negative lens G8 are assembled in order to form the cemented lens Gcomp. This makes it possible to effectively correct axial chromatic aberration at short wavelengths, such as the g-line.

Further, in the optical system L0 according to the eighth embodiment, the aperture stop SP is arranged adjacent to the image side of the front lens unit LF. This enables a reduction in the stop diameter of the aperture stop SP.

Next, configurations that the optical system L0 according to each embodiment can satisfy will be described.

In the optical system L0 according to each embodiment, at least one of the first to third air lenses counted from the object side can have a biconvex shape. This makes it possible to arrange a lens with strong negative refractive power at a position distant from the aperture stop SP, and the positive Petzval sum can be reduced while reducing sagittal flare caused by the strong negative refractive power, thereby making it possible to effectively correct field curvature.

In the optical system L0 according to each embodiment, the front lens unit LF can include the negative lens G1, the negative lens G2, the negative lens G3, and the positive lens G4 in order from the object side. Since the lens G4 is a positive lens, it becomes possible to effectively correct barrel distortion and magnification chromatic aberration generated by the lenses G1 to G3.

In optical systems L0 according to the first, second, fourth, fifth, and sixth embodiments, the front lens unit LF can include two negative meniscus lenses arranged closest to the object side in succession and each having an object-side lens surface convex toward the object side. This makes it possible to effectively correct distortion, field curvature, and astigmatism.

In the first, second, fourth, fifth, and sixth embodiments, the front lens unit LF can include three negative lenses arranged closest to the object side in succession in the optical axis direction. A wide-angle lens has strong negative refractive power on the object side of the optical system L0 to ensure sufficient back focus. By distributing this negative refractive power across the three negative lenses, the refractive power per negative lens can be reduced, thereby enabling a reduction of barrel-shaped distortion and field curvature. It should be noted that in the present disclosure, the three negative lenses arranged in succession indicate that no positive lenses are arranged between the three negative lenses.

In the optical systems L0 according to the first, second, fourth, fifth, and sixth embodiments, at least one of the three negative lenses arranged in succession on the object side within the front lens unit LF can be an aspherical lens. This makes it possible to effectively correct distortion and astigmatism. Further, in the first and fifth embodiments, the lenses G1 and G3 are aspherical lenses, thereby enhancing the above-described effect. Further, the aspherical lenses are shaped so that the absolute value of the peripheral curvature is less than the absolute value of the curvature on the optical axis, thereby making it possible to effectively correct distortion.

In the optical systems L0 according to the first and fifth embodiments, the lens G4 can be a meniscus lens with positive refractive power. This makes it possible to correct barrel distortion and magnification chromatic aberration.

The lens G4 may be a positive meniscus lens having an object-side lens surface convex toward the object side, or may be a positive meniscus lens having an image-side lens surface convex toward the image side.

In the optical system L0 according to each embodiment, the front lens unit LF can include at least one compound lens consisting of a positive lens and a negative lens. This makes it possible to effectively correct axial chromatic aberration and magnification chromatic aberration. Furthermore, the negative lens Gn that satisfies the inequalities (6) and (7) can be used as a negative lens in the compound lens as in the second, third, fourth, sixth, and seventh embodiments, thereby making it possible to more effectively correct axial chromatic aberration at the g-line.

In the optical system L0 according to each embodiment, at least some of the lenses constituting the front lens unit LF may be configured to move to include a component in the direction orthogonal to the optical axis, thereby making it possible to correct image blur. For example, in the seventh and eighth embodiments, the lens G8 moves to include a component in the direction orthogonal to the optical axis during image blur correction. However, this is not intended to be limiting. Further, at least a positive lens and a negative lens may be included as lenses configured to move during image blur correction, thereby enabling a reduction in variations in chromatic aberration during image blur correction. Further, three or more lenses may be configured to move during image blur correction.

In the optical system L0 according to each embodiment, the image-side focusing unit LFR includes a negative lens and a positive lens arranged in order in the optical axis direction. This makes it possible to more effectively correct axial chromatic aberration at infinity focus and variations in axial chromatic aberration during focusing. It should be noted that the above-described effect is achieved regardless of the order in which the negative lens and the positive lens are arranged.

Further, in the optical system L0 according to each embodiment, the lens arranged closest to the object side within the image-side focusing unit LFR can have an object-side lens surface concave toward the object side. Further, the second lens counted from the object side can have an image-side lens surface convex toward the image side. As a result, the lens surface has a substantially concentric shape with respect to off-axis light incident on the image-side focusing unit LFR, thereby enabling a reduction in variations in aberration and angle of view during focusing.

In the optical system L0 according to each embodiment, the image-side focusing unit LFR includes a compound lens formed by assembling at least one negative lens Gn and at least one positive lens G2p. This makes it possible to effectively correct axial chromatic aberration at infinity focus and variations in axial chromatic aberration during focusing.

Further, the compound lens can be arranged closest to the object side within the image-side focusing unit LFR.

As a result, the compound lens is arranged at a position where the height of the on-axis marginal ray from the optical axis is large, thereby making it possible to more effectively correct axial chromatic aberration.

Further, the compound lens has a lens surface closest to the object side and a lens surface closest to the image side, and the lens surface closest to the object side can be concave toward the object side, while the lens surface closest to the image side can be convex toward the image side. As a result, a substantially concentric shape is formed with respect to off-axis light incident on the image-side focusing unit LFR, thereby making it possible to reduce variations in aberration and angle of view during focusing. It should be noted that the compound lens may be formed by assembling a biconcave lens and a biconvex lens in order from the object side.

In the optical system L0 according to each embodiment, the image-side focusing unit LFR can consist of five or fewer lenses. This makes it possible to reduce the lens weight of the image-side focusing unit LFR, thereby achieving high-speed focusing. Further, the refractive power per lens can be reduced, thereby making it possible to reduce variations in spherical aberration, field curvature, and chromatic aberration during focusing. It should be noted that the image-side focusing unit LFR can consist of four or fewer lenses to enhance the above-described effect. Further, the image-side focusing unit LFR can consist of three or fewer lenses.

In the optical system L0 according to each embodiment, the object-side lens surface of the lens arranged closest to the object side within the image-side focusing unit LFR can be concave toward the object side. This causes the off-axis light after passing through the aperture stop SP to be incident substantially concentrically on the surface closest to the object side within the image-side focusing unit LFR, thereby facilitating a reduction in astigmatism, comatic aberration, and angle of view during focusing.

In the optical system L0 according to each embodiment, the image-side focusing unit LFR can include an aspherical lens having at least one aspherical surface. This makes it possible to effectively correct spherical aberration, astigmatism, and comatic aberration. Further, a surface of the positive lens included in the image-side focusing unit LFR can have an aspherical surface, thereby making it possible to reduce surface shape errors during molding. Further, the lens closest to the image side or the second lens counted from the image side within the image-side focusing unit LFR can have an aspherical surface, thereby making it possible to effectively correct off-axis aberrations, such as astigmatism and comatic aberration.

In the optical systems L0 according to the first to sixth embodiments, the rear lens unit LR can include a compound lens consisting of a positive lens and a negative lens. This makes it possible to effectively correct magnification chromatic aberration and astigmatism.

In the optical system L0 according to each embodiment, an organic material, such as plastic, or a glass material may be used as an aspherical lens material. Further, an aspherical lens made from an organic material, such as plastic, may be formed on a spherical glass by molding, joining, or bonding the organic material having a thickness of approximately 0.01 mm to approximately 1.00 mm onto the spherical glass.

In the optical system L0 according to the seventh embodiment, the aspherical lens G12 arranged in the image-side focusing unit LFR is made from a plastic material. As described above, at least one of the lenses arranged within the image-side focusing unit LFR can be made from a plastic material to reduce the weight of the image-side focusing unit LFR.

In the optical system L0 according to each embodiment, the combined focal length fGcomp of the cemented lens Gcomp arranged within the front lens unit LF can be a positive value. This makes it possible to effectively correct axial chromatic aberration and reduce the diameters of the lenses arranged on the object side of the image-side focusing unit LFR.

In the optical system L0 according to each embodiment, the positive lens Gp can be made from an organic resin material. This makes it possible to reduce the weight of the entire optical system L0. Further, it becomes possible to achieve the anomalous partial dispersibility required for the positive lens Gp as defined in the inequality (1).

Examples of materials that satisfy the inequality (1) include resins and mixtures of resins and fine particles of inorganic oxides. Examples of inorganic oxides include TiO₂ (nd=2.304, νd=13.8), Nb₂O₅ (nd=2.367, νd=14.0), and ITO (nd=1.8571, νd=5.69). Other examples are CrO₃ (nd=2.2178, νd=13.4) and BaTiO₃ (nd=2.4362, νd=11.3). It should be noted that the refractive index of each material with respect to the d-line is denoted by nd.

A material that satisfies the inequality (1) can be obtained by dispersing fine particles of an inorganic oxide described above into a solid material at an appropriate volume ratio. Considering the scattering of the material, the particle size of the fine particles can be 2 nm to 50 nm. A dispersant or the like may be added to suppress aggregation.

In the optical system L0 according to each embodiment, the refractive index of the positive lens with the greatest refractive power among the positive lenses constituting the cemented lens Gcomp can be set to a value of 1.65 or greater and 2.1 or less.

In a case where the positive lens Gp constituting the cemented lens Gcomp is made from a resin material, the positive lens Gp may deform due to an external environmental change such as a temperature fluctuation or moisture absorption, and a positive lens joined to the object or image side of the positive lens Gp may also deform. In a case where the refractive index of the positive lens joined to the positive lens Gp is less than 1.65, the mechanical hardness of the positive lens, i.e., the Young's modulus, Knoop hardness, or the like of a material of the positive lens, decreases. This often leads to greater deformation of the positive lens, causing greater variations in aberrations such as spherical aberration. Accordingly, this should be avoided. Further, the refractive index can be set to a value of 1.70 or greater, or a value of 1.75 or greater.

Further, the refractive index of the positive lens joined to the positive lens Gp can be set to 2.1 or less, thereby making it possible to effectively correct axial chromatic aberration.

In the optical system L0 according to each embodiment, the Abbe number of the positive lens with the greatest refractive power among the positive lenses constituting the cemented lens Gcomp can be set to a value of 25 or greater and 60 or less with respect to the d-line.

In a case where the positive lens joined to the positive lens Gp has an Abbe number greater than 60 with respect to the d-line, the mechanical hardness of the positive lens decreases. This often leads to greater deformation of the positive lens associated with deformation of the positive lens Gp, causing greater variations in aberrations such as spherical aberration. Accordingly, this should be avoided. Further, the Abbe number can be set to 56 or less, or 53 or less.

Further, in a case where the positive lens joined to the positive lens Gp has an Abbe number less than 25 with respect to the d-line, it becomes difficult to correct axial chromatic aberration. Accordingly, this should be avoided.

First to eighth numerical embodiments corresponding to the first to eighth embodiments, respectively, will be specified.

In the surface data of each numerical embodiment, r denotes the radius of curvature of each optical surface, and d (mm) denotes the distance along the optical axis between the m-th surface and the (m+1)-th surface, where m is the number of the surface counted from the light incident side. Further, nd denotes the refractive index of the material of each optical member with respect to the d-line, and νd denotes the Abbe number of the material of each optical member. It should be noted that the Abbe number νd and the partial dispersion ratio θgF of a material are expressed as follows:

$$vd = ( Nd - 1 ) / ( NF - NC ) ;$$

$$and$$

$$θ gF = ( Ng - NF ) / ( NF - NC ) ,$$

where Nd, NF, NC, and Ng denote the refractive indices at the Fraunhofer d-line (587.6 nm), F-line (486.1 nm), C-line (656.3 nm), and g-line (wavelength: 435.8 nm), respectively.

It should be noted that in each numerical embodiment, all of d, focal length (mm), f-number, and half angle of view (°) are values obtained when the optical system according to each embodiment is focused at infinity. The back focus BF refers to the air-equivalent distance from the final lens surface to the image plane. The total optical length refers to a value obtained by adding the air-equivalent back focus to the distance from the first lens surface to the final lens surface. It should be noted that optical members corresponding to an optical filter, a face plate, a crystal low-pass filter, an infrared cut filter, and the like are not included.

Further, the symbol “*” is appended to the right of each surface number corresponding to an aspherical lens surface of a lens. An aspherical shape is expressed as follows:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12} + A 14 \times {h}^{14} + A 16 \times {h}^{16} ,$$

where X denotes an amount of displacement from a surface vertex in the optical axis direction, h denotes a height from the optical axis in a direction perpendicular to the optical axis, R denotes a paraxial radius of curvature, k denotes a conic constant, and A4, A6, A8, A10, A12, A14, and A16 denote aspherical surface coefficients of respective orders. It should be noted that “e±XX” in each aspherical surface coefficient indicates “×10±^{XX}”.

[First Numerical Embodiment]
Unit mm
Surface data

| Surface number | r | d | nd | νd |
|---|---|---|---|---|
| 1* | 30.434 | 2.50 | 1.58313 | 59.4 |
| 2* | 12.960 | 14.47 | | |
| 3 | −8220.485 | 1.60 | 1.49700 | 81.7 |
| 4 | 48.726 | 5.09 | | |
| 5 | −52.293 | 2.00 | 1.80400 | 46.5 |
| 6* | 61.254 | 0.20 | | |
| 7 | 30.423 | 3.13 | 1.66565 | 35.6 |
| 8 | 60.805 | 4.01 | | |
| 9 | −38.272 | 1.20 | 1.43387 | 95.1 |
| 10 | 89.263 | 0.20 | | |
| 11 | 33.379 | 9.18 | 1.75500 | 52.3 |
| 12 | −25.609 | 1.05 | 1.84666 | 23.8 |
| 13 | −50.774 | 0.20 | | |
| 14 | 121.888 | 4.07 | 1.83481 | 42.7 |
| 15 | −55.780 | 3.62 | | |
| 16 | −26.631 | 1.10 | 1.77047 | 29.7 |
| 17 | −79.426 | 2.00 | | |
| 18 (stop) | ∞ | 2.43 | | |
| 19 | 52.498 | 5.84 | 2.00100 | 29.1 |
| 20 | −45.067 | 1.00 | 1.57060 | 20.1 |
| 21 | −32.493 | 1.10 | 1.66565 | 35.6 |
| 22 | 71.141 | (variable) | | |
| 23 | −120.281 | 7.55 | 1.43875 | 94.7 |
| 24 | −14.562 | 1.00 | 1.77047 | 29.7 |
| 25 | −57.242 | 0.20 | | |
| 26 | 39.251 | 8.64 | 1.49700 | 81.7 |
| 27 | −31.928 | 0.60 | | |
| 28* | 137.086 | 4.68 | 1.85400 | 40.4 |
| 29* | −65.817 | (variable) | | |
| 30 | −1214.157 | 7.51 | 1.59282 | 68.6 |
| 31 | −22.877 | 1.05 | 1.91650 | 31.6 |
| 32 | 331.855 | 14.00 | | |
| Image plane | ∞ | | | |

Aspherical surface data
First surface

| | | |
|---|---|---|
| K = 0.00000e+00 | A4 = −9.44889e−06 | A6 = −2.78211e−09 |
| A8 = 1.38292e−11 | A10 = −1.87056e−14 | A12 = 7.67401e−18 |

Second surface

| | | |
|---|---|---|
| K = −6.82090e−01 | A4 = −2.16920e−06 | A6 = −9.17628e−09 |
| A8 = −2.33882e−10 | A10 = 8.26939e−13 | A12 = −1.85607e−15 |

Sixth surface

| | | |
|---|---|---|
| K = 0.00000e+00 | A4 = 2.29625e−05 | A6 = 1.76297e−08 |
| A8 = 4.18666e−10 | A10 = −2.45395e−12 | A12 = 6.29348e−15 |

Twenty-eighth surface

| | | |
|---|---|---|
| K = 0.00000e+00 | A4 = −2.17900e−05 | A6 = −7.22596e−09 |
| A8 = −1.48661e−10 | A10 = 1.85432e−12 | A12 = −3.03305e−15 |

Twenty-ninth surface

| | | |
|---|---|---|
| K = 0.00000e+00 | A4 = −1.07831e−05 | A6 = −3.03321e−09 |
| A8 = −5.03844e−11 | A10 = 1.22127e−12 | A12 = −1.50312e−15 |

| | |
|---|---|
| Focal length | 14.42 |
| f-number | 1.46 |
| Half angle of view | 52.34 |
| Image height | 18.68 |
| Total optical length | 118.50 |
| BF | 14.00 |

| | Focused at object distance corresponding | |
|---|---|---|
| Focused at infinity | to a lateral magnification of −0.1 | |
| From object surface to | Infinity | 240.532 |
| first surface | | |
| d22 | 5.08 | 4.08 |
| d29 | 2.20 | 3.21 |

Lens unit data

| Unit | Starting surface | Focal length |
|---|---|---|
| L1 | 1 | 36.30 |
| L2 | 23 | 28.35 |
| L3 | 30 | −57.28 |

Single lens data

| Lens | Starting surface | Focal length | θgF |
|---|---|---|---|
| 1 | 1 | −40.86 | |
| 2 | 3 | −97.46 | |
| 3 | 5 | −34.81 | |
| 4 | 7 | 87.86 | |
| 5 | 9 | −61.56 | |
| 6 | 11 | 20.57 | |
| 7 | 12 | −62.22 | |
| 8 | 14 | 46.32 | |
| 9 | 16 | −52.47 | 0.5951 |
| 10 | 19 | 24.97 | |
| 11 | 20 | 198.38 | 0.7782 |
| 12 | 21 | −33.37 | 0.5824 |
| 13 | 23 | 36.96 | |
| 14 | 24 | −25.61 | 0.5951 |
| 15 | 26 | 36.91 | |
| 16 | 28 | 52.63 | |
| 17 | 30 | 39.24 | |
| 18 | 31 | −23.32 | |

[Second Numerical Embodiment]
Unit mm
Surface data

| Surface number | r | d | nd | νd |
|---|---|---|---|---|
| 1 | 52.423 | 1.40 | 1.60311 | 60.6 |
| 2 | 19.691 | 5.03 | | |
| 3 | 29.399 | 2.00 | 1.58313 | 59.4 |
| 4* | 17.890 | 16.43 | | |
| 5 | −23.409 | 1.20 | 1.43875 | 94.7 |
| 6 | −99.819 | 0.50 | | |
| 7 | 167.077 | 8.86 | 1.75500 | 52.3 |
| 8 | −20.287 | 1.05 | 1.85478 | 24.8 |
| 9 | −46.575 | 0.25 | | |
| 10 | 70.946 | 5.42 | 1.90043 | 37.4 |
| 11 | −70.946 | 0.96 | | |
| 12 | 184.489 | 1.10 | 1.54072 | 47.2 |
| 13 | 50.592 | 4.99 | | |
| 14 (stop) | ∞ | 2.18 | | |
| 15 | 124.113 | 3.80 | 2.00069 | 25.5 |
| 16 | −86.925 | 0.70 | 1.57060 | 20.1 |
| 17 | −58.110 | 1.10 | 1.66565 | 35.6 |
| 18 | 92.703 | (variable) | | |
| 19 | −31.832 | 5.02 | 1.49700 | 81.7 |
| 20 | −16.428 | 1.00 | 1.77047 | 29.7 |
| 21 | −103.188 | 0.20 | | |
| 22 | 40.261 | 8.11 | 1.49700 | 81.7 |
| 23 | −34.315 | 2.75 | | |
| 24* | 87.489 | 5.76 | 1.80400 | 46.5 |
| 25* | −54.320 | (variable) | | |
| 26 | 326.711 | 6.95 | 1.59282 | 68.6 |
| 27 | −29.793 | 1.05 | 1.66565 | 35.6 |
| 28 | 59.878 | 18.44 | | |
| Image plane | ∞ | | | |

Aspherical surface data
Fourth surface

| | | |
|---|---|---|
| K = −4.88704e+00 | A4 = 9.85206e−05 | A6 = −4.60796e−07 |
| A8 = 2.61477e−09 | A10 = −1.06987e−11 | A12 = 2.62680e−14 |
| A14 = −2.76184e−17 | | |

Twenty-fourth surface

| | | |
|---|---|---|
| K = 0.00000e+00 | A4 = −8.28107e−06 | A6 = 7.81678e−09 |
| A8 = −5.60781e−11 | A10 = 2.06771e−13 | A12 = −4.03084e−16 |

Twenty-fifth surface

| | | |
|---|---|---|
| K = 0.00000e+00 | A4 = 6.09726e−06 | A6 = 5.11495e−09 |
| A8 = −1.22444e−11 | A10 = 1.38078e−13 | A12 = −2.89951e−16 |

| | |
|---|---|
| Focal length | 20.60 |
| f-number | 1.46 |
| Half angle of view | 42.54 |
| Image height | 18.90 |
| Total optical length | 117.50 |
| BF | 18.44 |

| | Focused at object distance corresponding | |
|---|---|---|
| Focused at infinity | to a lateral magnification of −0.1 | |
| From object surface to | Infinity | 300.024 |
| first surface | | |
| d18 | 9.05 | 7.44 |
| d25 | 2.20 | 3.81 |

Lens unit data

| Unit | Starting surface | Focal length |
|---|---|---|
| L1 | 1 | 45.15 |
| L2 | 19 | 32.25 |
| L3 | 26 | −85.88 |

Single lens data

| Lens | Starting surface | Focal length | θgF |
|---|---|---|---|
| 1 | 1 | −53.14 | |
| 2 | 3 | −83.73 | |
| 3 | 5 | −70.04 | |
| 4 | 7 | 24.46 | |
| 5 | 8 | −42.84 | 0.6122 |
| 6 | 10 | 40.12 | |
| 7 | 12 | −129.29 | |
| 8 | 15 | 51.55 | |
| 9 | 16 | 304.54 | 0.7782 |
| 10 | 17 | −53.51 | 0.5824 |
| 11 | 19 | 61.63 | |
| 12 | 20 | −25.49 | 0.5951 |
| 13 | 22 | 38.67 | |
| 14 | 24 | 42.45 | |
| 15 | 26 | 46.39 | |
| 16 | 27 | −29.75 | |

[Third Numerical Embodiment]
Unit mm
Surface data

| Surface number | r | d | nd | νd |
|---|---|---|---|---|
| 1 | 53.831 | 1.05 | 1.72916 | 54.7 |
| 2 | 22.346 | 14.69 | | |
| 3 | −29.419 | 1.00 | 1.48749 | 70.2 |
| 4 | 188.029 | 3.89 | | |
| 5 | −203.116 | 8.40 | 1.83481 | 42.7 |
| 6 | −20.865 | 1.05 | 1.85478 | 24.8 |
| 7 | −47.144 | 0.20 | | |
| 8 | 49.538 | 4.97 | 2.00069 | 25.5 |
| 9 | −184.719 | (variable) | | |
| 10 | 115.985 | 1.10 | 1.61340 | 44.3 |
| 11 | 45.795 | (variable) | | |
| 12 (stop) | ∞ | 1.48 | | |
| 13 | 74.195 | 6.89 | 1.75500 | 52.3 |
| 14 | −31.627 | 0.50 | 1.57060 | 20.1 |
| 15 | −29.087 | 1.00 | 1.66565 | 35.6 |
| 16 | 87.405 | (variable) | | |
| 17 | −34.716 | 5.17 | 1.49700 | 81.7 |
| 18 | −16.180 | 1.00 | 1.85478 | 24.8 |
| 19 | −210.624 | 0.20 | | |
| 20 | 56.336 | 8.47 | 1.49700 | 81.7 |
| 21 | −27.668 | 0.94 | | |
| 22* | 90.528 | 6.73 | 1.80400 | 46.5 |
| 23* | −46.782 | (variable) | | |
| 24 | 119.008 | 6.50 | 1.92286 | 20.9 |
| 25 | −55.757 | 1.05 | 1.66565 | 35.6 |
| 26 | 38.876 | 5.37 | | |
| 27 | −85.461 | 1.00 | 1.51742 | 52.4 |
| 28 | −595.711 | 15.00 | | |
| Image plane | ∞ | | | |

Aspherical surface data
Twenty-second surface

| | | |
|---|---|---|
| K = 0.00000e+00 | A4 = −8.63588e−06 | A6 = 2.87015e−09 |
| A8 = −1.46350e−11 | A10 = 5.23093e−14 | A12 = −1.23076e−16 |

Twenty-third surface

| | | |
|---|---|---|
| K = 0.00000e+00 | A4 = 3.58608e−06 | A6 = 3.19398e−09 |
| A8 = −1.61487e−11 | A10 = 1.02393e−13 | A12 = −1.58745e−16 |

| | |
|---|---|
| Focal length | 24.72 |
| f-number | 1.46 |
| Angle of view | 37.40 |
| Image height | 18.90 |
| Total lens length | 117.50 |
| BF | 15.00 |

| | Focused at object distance corresponding | |
|---|---|---|
| Focused at infinity | to a lateral magnification of −0.1 | |
| From object surface to | Infinity | 226.884 |
| first surface | | |
| d9 | 0.50 | 2.71 |
| d11 | 8.51 | 6.31 |
| d16 | 8.64 | 6.89 |
| d23 | 2.20 | 3.95 |

Lens unit data

| | | | Lens | | |
|---|---|---|---|---|---|
| | Starting | Focal | structure | Front principal | Rear principal |
| Unit | surface | length | length | point position | point position |
| L1 | 1 | 41.33 | 35.24 | 34.50 | 28.24 |
| L2 | 10 | −124.11 | 1.10 | 1.13 | 0.45 |
| L3 | 12 | 183.91 | 9.87 | −3.63 | −9.67 |
| L4 | 17 | 34.38 | 22.51 | 16.76 | 6.16 |
| L5 | 24 | −106.17 | 13.92 | 10.87 | 0.43 |

Single lens data

| Lens | Starting surface | Focal length | θgF |
|---|---|---|---|
| 1 | 1 | −53.14 | |
| 2 | 3 | −52.11 | |
| 3 | 5 | 27.28 | |
| 4 | 6 | −44.61 | 0.6122 |
| 5 | 8 | 39.45 | |
| 6 | 10 | −124.11 | 0.5633 |
| 7 | 13 | 30.22 | |
| 8 | 14 | 592.30 | 0.7782 |
| 9 | 15 | −32.67 | 0.5824 |
| 10 | 17 | 55.81 | |
| 11 | 18 | −20.55 | 0.6122 |
| 12 | 20 | 38.63 | |
| 13 | 22 | 39.22 | |
| 14 | 24 | 41.89 | |
| 15 | 25 | −34.26 | |
| 16 | 27 | −192.96 | |

[Fourth Numerical Embodiment]
Unit mm
Surface data

| Surface number | r | d | nd | νd |
|---|---|---|---|---|
| 1* | 61.501 | 2.00 | 1.58313 | 59.4 |
| 2* | 20.184 | 9.47 | | |
| 3 | 1901.390 | 1.80 | 1.49700 | 81.7 |
| 4 | 42.169 | 2.76 | | |
| 5 | 159.837 | 2.00 | 1.76802 | 49.2 |
| 6* | 92.467 | 10.72 | | |
| 7 | −28.269 | 1.20 | 1.43387 | 95.1 |
| 8 | 80.363 | 0.50 | | |
| 9 | 44.572 | 9.93 | 1.72916 | 54.7 |
| 10 | −25.481 | 1.05 | 1.84666 | 23.8 |
| 11 | −53.627 | 0.25 | | |
| 12 | 82.209 | 5.46 | 1.81600 | 46.6 |
| 13 | −50.551 | 1.71 | | |
| 14 | −37.489 | 1.10 | 1.62205 | 41.1 |
| 15 | −87.960 | 2.83 | | |
| 16 (stop) | ∞ | 2.32 | | |
| 17 | 147.999 | 4.55 | 2.00069 | 25.5 |
| 18 | −49.961 | 1.00 | 1.57060 | 20.1 |
| 19 | −35.594 | 1.10 | 1.66565 | 35.6 |
| 20 | 67.510 | (variable) | | |
| 21 | −39.085 | 5.89 | 1.43875 | 94.7 |
| 22 | −15.511 | 1.00 | 1.77047 | 29.7 |
| 23 | −82.267 | 0.20 | | |
| 24 | 39.313 | 7.60 | 1.49700 | 81.7 |
| 25 | −35.308 | 2.28 | | |
| 26* | 99.752 | 5.96 | 1.80400 | 46.5 |
| 27* | −45.519 | (variable) | | |
| 28 | 575.113 | 7.49 | 1.59282 | 68.6 |
| 29 | −25.634 | 1.05 | 1.66565 | 35.6 |
| 30 | 61.536 | 17.78 | | |
| Image plane | ∞ | | | |

Aspherical surface data
First surface

| | | |
|---|---|---|
| K = 0.00000e+00 | A4 = 1.29176e−06 | A6 = −2.09110e−09 |
| A8 = 4.38333e−12 | | |

Second surface

| | | |
|---|---|---|
| K = −3.24571e−01 | A4 = −5.71201e−06 | A6 = −1.03383e−08 |
| A8 = −7.16243e−11 | | |

Sixth surface

| | | |
|---|---|---|
| K = −7.00000e+00 | A4 = 1.58032e−05 | A6 = 1.44025e−08 |
| A8 = 2.02465e−10 | A10 = −6.06022e−13 | A12 = 1.67729e−15 |

Twenty-sixth surface

| | | |
|---|---|---|
| K = 0.00000e+00 | A4 = −1.06246e−05 | A6 = −7.22658e−09 |
| A8 = 2.73322e−11 | A10 = 9.27530e−14 | A12 = −1.23176e−16 |

Twenty-seventh surface

| | | |
|---|---|---|
| K = 0.00000e+00 | A4 = 5.05881e−06 | A6 = −6.17326e−09 |
| A8 = 4.07297e−11 | A10 = 1.05263e−13 | A12 = −6.79698e−17 |

| | |
|---|---|
| Focal length | 18.45 |
| f-number | 1.46 |
| Angle of view | 45.46 |
| Image height | 18.75 |
| Total lens length | 121.17 |
| BF | 17.78 |
| d20 | 7.96 |
| d27 | 2.20 |

Lens unit data

| | | | Lens | | |
|---|---|---|---|---|---|
| | Starting | Focal | structure | Front principal | Rear principal |
| Unit | surface | length | length | point position | point position |
| L1 | 1 | 47.25 | 61.75 | 44.85 | 39.61 |
| L2 | 21 | 30.00 | 22.93 | 15.17 | 1.79 |
| L3 | 28 | −79.53 | 8.54 | 5.66 | 0.30 |

Single lens data

| Lens | Starting surface | Focal length | θgF |
|---|---|---|---|
| 1 | 1 | −52.46 | |
| 2 | 3 | −86.80 | |
| 3 | 5 | −289.37 | |
| 4 | 7 | −48.04 | |
| 5 | 9 | 23.65 | |
| 6 | 10 | −58.34 | |
| 7 | 12 | 39.08 | |
| 8 | 14 | −105.92 | 0.5690 |
| 9 | 17 | 37.76 | |
| 10 | 18 | 211.58 | 0.7782 |
| 11 | 19 | −34.86 | 0.5824 |
| 12 | 21 | 54.46 | |
| 13 | 22 | −24.97 | 0.5951 |
| 14 | 24 | 38.74 | |
| 15 | 26 | 39.60 | |
| 16 | 28 | 41.59 | |
| 17 | 29 | −27.06 | |

[Fifth Numerical Embodiment]
Unit mm
Surface data

| Surface number | r | d | nd | νd |
|---|---|---|---|---|
| 1* | 31.090 | 2.50 | 1.58313 | 59.4 |
| 2* | 13.099 | 14.59 | | |
| 3 | −530.553 | 1.70 | 1.49700 | 81.7 |
| 4 | 47.214 | 5.63 | | |
| 5 | −49.986 | 2.00 | 1.80400 | 46.5 |
| 6* | 87.783 | 0.20 | | |
| 7 | 31.641 | 3.06 | 1.66565 | 35.6 |
| 8 | 68.370 | 3.74 | | |
| 9 | −36.085 | 1.20 | 1.43387 | 95.1 |
| 10 | 60.775 | 0.20 | | |
| 11 | 32.009 | 8.73 | 1.75500 | 52.3 |
| 12 | −25.657 | 1.05 | 1.84666 | 23.8 |
| 13 | −54.614 | 0.20 | | |
| 14 | 167.133 | 3.92 | 1.83481 | 42.7 |
| 15 | −53.249 | 4.34 | | |
| 16 | −24.473 | 1.10 | 1.77047 | 29.7 |
| 17 | −65.694 | 2.00 | | |
| 18 (stop) | ∞ | 1.68 | | |
| 19 | 50.345 | 6.13 | 2.00100 | 29.1 |
| 20 | −44.102 | 1.00 | 1.57060 | 20.1 |
| 21 | −32.378 | 1.10 | 1.66565 | 35.6 |
| 22 | 87.176 | (variable) | | |
| 23 | −140.226 | 7.75 | 1.43875 | 94.7 |
| 24 | −14.948 | 1.00 | 1.77047 | 29.7 |
| 25 | −65.160 | 0.20 | | |
| 26 | 40.856 | 8.72 | 1.49700 | 81.7 |
| 27 | −31.383 | 0.20 | | |
| 28* | 128.494 | 4.66 | 1.85400 | 40.4 |
| 29* | −70.134 | (variable) | | |
| 30 | −319.132 | 7.26 | 1.59282 | 68.6 |
| 31 | −23.023 | 1.05 | 1.91650 | 31.6 |
| 32 | −1191.612 | 15.50 | | |
| Image plane | ∞ | | | |

Aspherical surface data
First surface

| | | |
|---|---|---|
| K = 0.00000e+00 | A4 = −1.01110e−05 | A6 = 8.17661e−10 |
| A8 = 8.93040e−12 | A10 = −1.54052e−14 | A12 = 7.63241e−18 |

Second surface

| | | |
|---|---|---|
| K = −6.44184e−01 | A4 = −6.39936e−06 | A6 = −1.43284e−08 |
| A8 = −2.16244e−10 | A10 = 7.31957e−13 | A12 = −1.78412e−15 |

Sixth surface

| | | |
|---|---|---|
| K = 0.00000e+00 | A4 = 2.13738e−05 | A6 = 2.10113e−08 |
| A8 = 3.60161e−10 | A10 = −2.14645e−12 | A12 = 6.19796e−15 |

Twenty-eighth surface

| | | |
|---|---|---|
| K = 0.00000e+00 | A4 = −2.11705e−05 | A6 = −5.23668e−09 |
| A8 = −1.83281e−10 | A10 = 1.81505e−12 | A12 = −2.71601e−15 |

Twenty-ninth surface

| | | |
|---|---|---|
| K = 0.00000e+00 | A4 = −1.02347e−05 | A6 = −7.27343e−09 |
| A8 = −3.83789e−11 | A10 = 1.01331e−12 | A12 = −1.00325e−15 |

| | |
|---|---|
| Focal length | 14.42 |
| f-number | 1.46 |
| Half angle of view | 52.34 |
| Image height | 18.68 |
| Total optical length | 119.50 |
| BF | 15.50 |

| | Focused at object distance corresponding | |
|---|---|---|
| Focused at infinity | to a lateral magnification of −0.1 | |
| From object surface to | Infinity | 241.623 |
| first surface | | |
| d22 | 4.90 | 3.89 |
| d29 | 2.20 | 3.21 |

Lens unit data

| Unit | Starting surface | Focal length |
|---|---|---|
| L1 | 1 | 36.74 |
| L2 | 23 | 29.10 |
| L3 | 30 | −65.56 |

Single lens data

| Lens | Starting surface | Focal length | θgF |
|---|---|---|---|
| 1 | 1 | −40.91 | |
| 2 | 3 | −87.15 | |
| 3 | 5 | −39.36 | |
| 4 | 7 | 85.64 | |
| 5 | 9 | −51.99 | |
| 6 | 11 | 20.18 | |
| 7 | 12 | −58.12 | |
| 8 | 14 | 48.77 | |
| 9 | 16 | −51.22 | 0.5951 |
| 10 | 19 | 24.27 | |
| 11 | 20 | 207.03 | 0.7782 |
| 12 | 21 | −35.34 | 0.5824 |
| 13 | 23 | 37.43 | |
| 14 | 24 | −25.40 | 0.5951 |
| 15 | 26 | 37.20 | |
| 16 | 28 | 53.71 | |
| 17 | 30 | 41.48 | |
| 18 | 31 | −25.63 | |

[Sixth Numerical Embodiment]
Unit mm
Surface data

| Surface number | r | d | nd | νd |
|---|---|---|---|---|
| 1 | 43.024 | 1.40 | 1.61800 | 63.4 |
| 2 | 20.105 | 5.66 | | |
| 3 | 32.408 | 2.00 | 1.58313 | 59.4 |
| 4* | 17.039 | 15.89 | | |
| 5 | −23.276 | 1.20 | 1.43875 | 94.7 |
| 6 | −65.876 | 0.50 | | |
| 7 | 1040.783 | 9.43 | 1.75500 | 52.3 |
| 8 | −20.743 | 1.05 | 1.85478 | 24.8 |
| 9 | −51.168 | 0.25 | | |
| 10 | 88.793 | 5.21 | 1.88100 | 40.1 |
| 11 | −61.610 | 0.25 | | |
| 12 | 53.033 | 1.10 | 1.48749 | 70.2 |
| 13 | 33.098 | 6.53 | | |
| 14 (stop) | ∞ | 1.38 | | |
| 15 | 56.211 | 4.07 | 2.00069 | 25.5 |
| 16 | −282.390 | 0.70 | 1.57060 | 20.1 |
| 17 | −106.816 | 1.10 | 1.61340 | 44.3 |
| 18 | 35.085 | (variable) | | |
| 19 | −55.827 | 6.01 | 1.49700 | 81.7 |
| 20 | −17.101 | 1.00 | 1.77047 | 29.7 |
| 21 | −285.670 | 0.20 | | |
| 22 | 49.100 | 7.70 | 1.49700 | 81.7 |
| 23 | −32.916 | 4.78 | | |
| 24* | 167.193 | 5.11 | 1.80400 | 46.5 |
| 25* | −71.686 | (variable) | | |
| 26 | 64.441 | 8.97 | 1.59282 | 68.6 |
| 27 | −37.571 | 1.05 | 1.66565 | 35.6 |
| 28 | 96.827 | 20.51 | | |
| Image plane | ∞ | | | |

Aspherical surface data
Fourth surface

| | | |
|---|---|---|
| K = −4.93669e+00 | A4 = 1.15091e−04 | A6 = −5.84829e−07 |
| A8 = 3.36673e−09 | A10 = −1.32319e−11 | A12 = 2.98902e−14 |
| A14 = −2.80832e−17 | | |

Twenty-fourth surface

| | | |
|---|---|---|
| K = 0.00000e+00 | A4 = −3.47747e−06 | A6 = −1.65912e−09 |
| A8 = 4.12770e−11 | A10 = −9.38830e−14 | A12 = −2.12904e−17 |

Twenty-fifth surface

| | | |
|---|---|---|
| K = 0.00000e+00 | A4 = 3.21233e−06 | A6 = 1.28708e−09 |
| A8 = 3.52617e−11 | A10 = −2.24322e−14 | A12 = −1.03425e−16 |

| | |
|---|---|
| Focal length | 20.60 |
| f-number | 1.50 |
| Half angle of view | 42.57 |
| Image height | 18.93 |
| Total optical length | 125.00 |
| BF | 20.51 |

| | Focused at object distance corresponding | |
|---|---|---|
| Focused at infinity | to a lateral magnification of −0.1 | |
| From object surface to | Infinity | 309.542 |
| first surface | | |
| d18 | 9.74 | 7.07 |
| d25 | 2.20 | 4.88 |

Lens unit data

| Unit | Starting surface | Focal length |
|---|---|---|
| L1 | 1 | 63.61 |
| L2 | 19 | 45.28 |
| L3 | 26 | 1142.84 |

Single lens data

| Lens | Starting surface | Focal length | θgF |
|---|---|---|---|
| 1 | 1 | −62.53 | |
| 2 | 3 | −64.71 | |
| 3 | 5 | −82.75 | |
| 4 | 7 | 27.04 | |
| 5 | 8 | −41.47 | 0.6122 |
| 6 | 10 | 41.97 | |
| 7 | 12 | −183.95 | |
| 8 | 15 | 47.13 | |
| 9 | 16 | 300.65 | 0.7782 |
| 10 | 17 | −42.93 | 0.5633 |
| 11 | 19 | 47.17 | |
| 12 | 20 | −23.65 | 0.5951 |
| 13 | 22 | 40.93 | |
| 14 | 24 | 63.00 | |
| 15 | 26 | 41.39 | |
| 16 | 27 | −40.54 | |

[Seventh Numerical Embodiment]
Unit mm
Surface data

| Surface number | r | d | nd | νd |
|---|---|---|---|---|
| 1 | 64.036 | 1.25 | 1.59270 | 35.3 |
| 2 | 19.134 | 5.47 | | |
| 3 | 29.144 | 6.99 | 2.05090 | 26.9 |
| 4 | −164.343 | 0.20 | | |
| 5 | −214.914 | 1.10 | 1.67270 | 32.1 |
| 6 | 20.824 | 6.60 | | |
| 7 | −23.834 | 0.90 | 1.58144 | 40.8 |
| 8 | 120.560 | 0.44 | | |
| 9 | 40.779 | 7.75 | 1.75500 | 52.3 |
| 10 | −22.714 | 0.50 | 1.60401 | 20.8 |
| 11 | −20.733 | 0.90 | 1.85478 | 24.8 |
| 12 | −31.966 | 4.45 | | |
| 13 (stop) | ∞ | 4.13 | | |
| 14 | 75.325 | 2.30 | 1.81600 | 46.6 |
| 15 | 30549.322 | (variable) | | |
| 16 | −17.256 | 3.03 | 1.49700 | 81.7 |
| 17 | −14.230 | 0.75 | 1.77047 | 29.7 |
| 18 | −22.527 | 0.20 | | |
| 19 | 67.123 | 6.11 | 1.49700 | 81.7 |
| 20 | −28.721 | 4.28 | | |
| 21* | −64.055 | 4.45 | 1.53500 | 56.0 |
| 22* | −24.736 | (variable) | | |
| 23 | 513.689 | 1.00 | 1.51742 | 52.4 |
| 24 | 60.438 | 7.24 | | |
| 25* | −28.526 | 2.25 | 1.53500 | 56.0 |
| 26* | −69.691 | 14.00 | | |
| Image plane | ∞ | | | |

Aspherical surface data
Twenty-first surface

| | | |
|---|---|---|
| K = 0.00000e+00 | A4 = −9.95374e−06 | A6 = 7.57077e−08 |
| A8 = −1.20581e−10 | A10 = 2.35597e−13 | |

Twenty-second surface

| | | |
|---|---|---|
| K = 0.00000e+00 | A4 = 1.95965e−05 | A6 = 4.39915e−08 |
| A8 = 1.12423e−10 | A10 = −5.83395e−13 | A12 = 1.49458e−15 |

Twenty-fifth surface

| | | |
|---|---|---|
| K = 0.00000e+00 | A4 = −6.90991e−06 | A6 = −3.19089e−08 |
| A8 = −1.15341e−10 | | |

Twenty-sixth surface

| | | |
|---|---|---|
| K = 0.00000e+00 | A4 = −2.04198e−05 | A6 = −1.90671e−08 |
| A8 = −2.89877e−11 | | |

| | |
|---|---|
| Focal length | 34.00 |
| f-number | 1.85 |
| Angle of view | 30.41 |
| Image height | 19.96 |
| Total lens length | 98.50 |
| BF | 14.00 |

| | Focused at object distance corresponding | |
|---|---|---|
| Focused at infinity | to a lateral magnification of −0.1 | |
| From object surface to | Infinity | 313.087 |
| first surface | | |
| d15 | 10.02 | 7.80 |
| d22 | 2.20 | 4.41 |

Lens unit data

| Unit | Starting surface | Focal length |
|---|---|---|
| L1 | 1 | 56.50 |
| L2 | 16 | 35.52 |
| L3 | 23 | −52.86 |

Single lens data

| Lens | Starting surface | Focal length | θgF |
|---|---|---|---|
| 1 | 1 | −46.52 | |
| 2 | 3 | 24.00 | |
| 3 | 5 | −28.17 | |
| 4 | 7 | −34.15 | |
| 5 | 9 | 20.39 | |
| 6 | 10 | 359.44 | 0.7230 |
| 7 | 11 | −71.67 | 0.6122 |
| 8 | 14 | 92.53 | |
| 9 | 16 | 122.53 | |
| 10 | 17 | −52.20 | 0.5951 |
| 11 | 19 | 41.35 | |
| 12 | 21 | 72.47 | |
| 13 | 23 | −132.48 | |
| 14 | 25 | −92.02 | |

[Eighth Numerical Embodiment]
Unit mm
Surface data

| Surface number | r | d | nd | νd |
|---|---|---|---|---|
| 1 | 53.821 | 1.25 | 1.59270 | 35.3 |
| 2 | 19.792 | 6.70 | | |
| 3 | 32.079 | 6.96 | 2.05090 | 26.9 |
| 4 | −197.061 | 0.20 | | |
| 5 | −219.698 | 1.10 | 1.69895 | 30.1 |
| 6 | 22.445 | 7.32 | | |
| 7 | −22.851 | 0.90 | 1.53172 | 48.8 |
| 8 | 128.035 | 0.20 | | |
| 9 | 42.517 | 8.54 | 1.81600 | 46.6 |
| 10 | −20.253 | 0.60 | 1.60401 | 20.8 |
| 11 | −18.556 | 0.90 | 1.85451 | 25.2 |
| 12 | −34.216 | 9.36 | | |
| 13 | 63.514 | 2.28 | 1.81600 | 46.6 |
| 14 | 406.615 | 1.50 | | |
| 15 (stop) | ∞ | (variable) | | |
| 16 | −15.762 | 0.90 | 1.85451 | 25.2 |
| 17 | −24.463 | 0.20 | | |
| 18 | 90.261 | 6.30 | 1.49700 | 81.7 |
| 19 | −23.179 | 3.61 | | |
| 20* | −159.864 | 4.42 | 1.76802 | 49.2 |
| 21* | −36.419 | (variable) | | |
| 22 | −433.667 | 1.00 | 1.56732 | 42.8 |
| 23 | 85.888 | 6.84 | | |
| 24* | −26.724 | 2.25 | 1.53500 | 56.0 |
| 25* | −63.795 | 13.00 | | |
| Image plane | ∞ | | | |

Aspherical surface data
Twentieth surface

| | | |
|---|---|---|
| K = 0.00000e+00 | A4 = 8.94338e−06 | A6 = 4.88458e−08 |
| A8 = 5.93594e−11 | A10 = −7.78918e−13 | |

Twenty-first surface

| | | |
|---|---|---|
| K = 0.00000e+00 | A4 = 2.50680e−05 | A6 = 3.79676e−08 |
| A8 = 2.03086e−10 | A10 = −1.01428e−12 | A12 = −1.35233e−16 |

Twenty-fourth surface

| | | |
|---|---|---|
| K = 0.00000e+00 | A4 = −5.82583e−06 | A6 = −2.82269e−08 |
| A8 = −1.68916e−10 | | |

Twenty-fifth surface

| | | |
|---|---|---|
| K = 0.00000e+00 | A4 = −1.70437e−05 | A6 = −3.50373e−08 |
| A8 = −3.50671e−11 | | |

| | |
|---|---|
| Focal length | 34.00 |
| f-number | 1.85 |
| Angle of view | 30.41 |
| Image height | 21.64 |
| Total lens length | 98.50 |
| BF | 13.00 |

| | Focused at object distance corresponding | |
|---|---|---|
| Focused at infinity | to a lateral magnification of −0.1 | |
| From object surface to | Infinity | 310.391 |
| first surface | | |
| d15 | 9.97 | 7.59 |
| d21 | 2.20 | 4.58 |

Lens unit data

| Unit | Starting surface | Focal length |
|---|---|---|
| L1 | 1 | 49.70 |
| L2 | 16 | 36.67 |
| L3 | 22 | −50.42 |

Single lens data

| Lens | Starting surface | Focal length | θgF |
|---|---|---|---|
| 1 | 1 | −53.55 | |
| 2 | 3 | 26.67 | |
| 3 | 5 | −29.08 | |
| 4 | 7 | −36.39 | |
| 5 | 9 | 17.91 | |
| 6 | 10 | 323.61 | 0.7230 |
| 7 | 11 | −48.74 | 0.6103 |
| 8 | 13 | 91.97 | |
| 9 | 16 | −54.46 | 0.6103 |
| 10 | 18 | 37.81 | |
| 11 | 20 | 60.47 | |
| 12 | 22 | −126.28 | |
| 13 | 24 | −87.82 | |

Tables 1 and 2 collectively present various values in the numerical embodiments.

TABLE 1

| | | First | Second | Third | Fourth | Fifth |
|---|---|---|---|---|---|---|
| | | Embodiment | Embodiment | Embodiment | Embodiment | Embodiment |
| f | | 14.420 | 20.600 | 24.720 | 18.450 | 14.420 |
| fLF | | 36.300 | 45.150 | 50.962 | 47.254 | 36.741 |
| fLFR | | 28.349 | 32.252 | 34.380 | 30.004 | 29.104 |
| fLR | | 57.275 | −85.884 | −106.174 | −79.531 | −65.560 |
| βLFR | | 0.317 | 0.378 | 0.427 | 0.320 | 0.313 |
| βLR | | 1.255 | 1.207 | 1.137 | 1.220 | 1.254 |
| L | | 118.500 | 117.502 | 117.500 | 121.166 | 119.500 |
| MLFR | | −1.005 | −1.614 | −1.748 | −2.423 | −1.005 |
| DSP | | 48.880 | 49.884 | 57.143 | 50.600 | 47.842 |
| sk | | 14.000 | 18.438 | 15.000 | 17.778 | 15.500 |
| ΣDair | | 40.301 | 44.537 | 46.620 | 43.200 | 40.075 |
| RLFR1 | | −120.2811616 | −31.83150292 | −34.71610324 | −39.08482367 | −140.2257251 |
| RLFR2 | | −65.81720476 | −54.31954289 | −46.78209846 | −45.51863357 | −70.13406558 |
| fGcomp | | 59.298 | 229.447 | 183.913 | 322.199 | 51.417 |
| Inequality (2) | sk/f | 0.971 | 0.895 | 0.607 | 0.964 | 1.075 |
| Inequality (3) | fLF/fLFR | 1.280 | 1.400 | 1.482 | 1.575 | 1.262 |
| Inequality (4) | f/fLR | −0.252 | −0.240 | −0.233 | −0.232 | −0.220 |
| Inequality (5) | (RLFR2 − | −0.293 | 0.261 | 0.148 | 0.076 | −0.333 |
| | RLFR1)/ | | | | | |
| | (RLFR2 + | | | | | |
| | RLFR1) | | | | | |
| Inequality (8) | (1-β2²)*β3² | 1.417 | 1.249 | 1.058 | 1.336 | 1.418 |
| Inequality (9) | sk/\|fLR\| | 0.244 | 0.215 | 0.141 | 0.224 | 0.236 |
| Inequality (10) | Σdair/(L-sk) | 0.386 | 0.450 | 0.455 | 0.418 | 0.385 |
| Inequality (11) | L/f | 8.218 | 5.704 | 4.753 | 6.567 | 8.287 |
| Inequality (13) | MLFR/DSP | −0.021 | −0.032 | −0.031 | −0.048 | −0.021 |
| Inequality (15) | fLFR/f | 1.966 | 1.566 | 1.391 | 1.626 | 2.018 |
| Inequality (16) | (DSP + sk)/L | 0.531 | 0.581 | 0.614 | 0.564 | 0.530 |
| Inequality (17) | fLF/f | 2.517 | 2.192 | 2.062 | 2.561 | 2.548 |
| Inequality (18) | f/fGcomp | 0.243 | 0.090 | 0.134 | 0.057 | 0.280 |

| | | Sixth | Seventh | Eighth |
|---|---|---|---|---|
| | | Embodiment | Embodiment | Embodiment |
| f | | 20.600 | 34.000 | 34.000 |
| fLF | | 63.607 | 56.502 | 49.705 |
| fLFR | | 45.280 | 35.520 | 36.672 |
| fLR | | 1142.838 | −52.863 | −50.415 |
| βLFR | | 0.350 | 0.443 | 0.505 |
| βLR | | 0.926 | 1.359 | 1.355 |
| L | | 125.000 | 98.501 | 98.501 |
| MLFR | | −2.677 | −2.215 | −2.379 |
| DSP | | 54.021 | 47.954 | 37.685 |
| sk | | 20.515 | 14.000 | 13.000 |
| ΣDair | | 47.381 | 45.222 | 48.102 |
| RLFR1 | | −55.82734267 | −17.25564415 | −15.76194647 |
| RLFR2 | | −71.68555874 | −24.73628795 | −36.41937358 |
| fGcomp | | 414.349 | 26.471 | 25.753 |
| Inequality (2) | sk/f | 0.996 | 0.41 | 0.382 |
| Inequality (3) | fLF/fLFR | 1.405 | 1.591 | 1.355 |
| Inequality (4) | f/fLR | 0.018 | −0.643 | −0.674 |
| Inequality (5) | (RLFR2 − | 0.124 | 0.178 | 0.396 |
| | RLFR1)/ | | | |
| | (RLFR2 + | | | |
| | RLFR1) | | | |
| Inequality (8) | (1-β2²)*β3² | 0.752 | 1.484 | 1.369 |
| Inequality (9) | sk/\|fLR\| | 0.018 | 0.265 | 0.258 |
| Inequality (10) | Σdair/(L-sk) | 0.453 | 0.535 | 0.56 |
| Inequality (11) | L/f | 6.068 | 2.897 | 2.89 |
| Inequality (13) | MLFR/DSP | −0.050 | −0.046 | −0.063 |
| Inequality (15) | fLFR/f | 2.198 | 1.045 | 1.079 |
| Inequality (16) | (DSP + sk)/L | 0.596 | 0.629 | 0.515 |
| Inequality (17) | fLF/f | 3.088 | 1.66 | 1.462 |
| Inequality (18) | f/fGcomp | 0.050 | 1.284 | 1.320 |

Table 2 collectively presents the lenses that satisfy the inequalities (1), (6), (7), (12), and (14) according to each numerical embodiment and various numerical values of the lenses.

TABLE 2

| | First | | Second | | Third | | Fourth | | |
|---|---|---|---|---|---|---|---|---|---|
| | Embodiment | | Embodiment | | Embodiment | | Embodiment | | |
| vd1n | G2 | 81.65 | G3 | 94.66 | G2 | 70.23 | G2 | 81.65 | |
| In- | G5 | 95.10 | | | | | G4 | 95.10 | |
| equality | | | | | | | | | |
| (14) | | | | | | | | | |
| vd2p | G13 | 94.66 | G11 | 81.65 | G10 | 81.65 | G12 | 94.66 | |
| In- | G15 | 81.65 | G13 | 81.65 | G12 | 81.65 | G14 | 81.65 | |
| equality | | | | | | | | | |
| (12) | | | | | | | | | |
| Ndn | G9 | 1.77047 | G5 | 1.85478 | G4 | 1.85478 | G8 | 1.62205 | |
| | G12 | 1.66565 | G10 | 1.66565 | G6 | 1.61340 | G11 | 1.66565 | |
| | G14 | 1.77047 | G12 | 1.77047 | G9 | 1.66565 | G13 | 1.77047 | |
| | | | | | G11 | 1.85478 | | | |
| vdn | G9 | 29.74 | G5 | 24.80 | G4 | 24.80 | G8 | 41.08 | |
| | G12 | 35.64 | G10 | 35.64 | G6 | 44.27 | G11 | 35.64 | |
| | G14 | 29.74 | G12 | 29.74 | G9 | 35.64 | G13 | 29.74 | |
| | | | | | G11 | 24.80 | | | |
| 0gFn | G9 | 0.5951 | G5 | 0.6122 | G4 | 0.6122 | G8 | 0.5690 | |
| | G12 | 0.5824 | G10 | 0.5824 | G6 | 0.5633 | G11 | 0.5824 | |
| | G14 | 0.5951 | G12 | 0.5951 | GS | 0.5824 | G13 | 0.5951 | |
| | | | | | G11 | 0.6122 | | | |
| vdp | G11 | 20.08 | G9 | 20.08 | G8 | 20.08 | G10 | 20.08 | |
| 0gFp | G11 | 0.7782 | G9 | 0.7782 | G8 | 0.7782 | G10 | 0.7782 | |
| In- | G11 | 0.14427 | G9 | 0.14427 | G8 | 0.14427 | G10 | 0.14427 | |
| equality | | | | | | | | | |
| (1) | | | | | | | | | |
| In- | G9 | −0.0047 | G5 | 0.0000 | G4 | 0.0000 | G8 | −0.0023 | |
| equality | G12 | −0.0025 | G10 | −0.0025 | G6 | 0.0000 | G11 | −0.0025 | |
| (6) | G14 | −0.0047 | G12 | −0.0047 | G9 | −0.0025 | G13 | −0.0047 | |
| | | | | | G11 | 0.0000 | | | |
| In- | G9 | −0.08434 | G5 | −0.07182 | G4 | −0.07182 | G8 | −0.06779 | |
| equality | G12 | −0.10331 | G10 | −0.10331 | G6 | −0.03006 | G11 | −0.10331 | |
| (7) | G14 | −0.08434 | G12 | −0.08434 | G9 | −0.10331 | G13 | −0.08434 | |
| | | | | | G11 | −0.07182 | | | |
| | | Fifth | | Sixth | | Seventh | | Eighth | |
| | | Embodiment | | Embodiment | | Embodiment | | Embodiment | |
| | vd1n | G2 | 81.65 | G3 | 94.66 | | | | |
| | In- | G5 | 95.10 | | | | | | |
| | equality | | | | | | | | |
| | (14) | | | | | | | | |
| | vd2p | G13 | 94.66 | G11 | 81.65 | G9 | 81.65 | G10 | 81.65 |
| | In- | G15 | 81.65 | G13 | 81.65 | G11 | 81.65 | | |
| | equality | | | | | | | | |
| | (12) | | | | | | | | |
| | Ndn | G9 | 1.77047 | G5 | 1.85478 | G7 | 1.85478 | G7 | 1.85451 |
| | | G12 | 1.66565 | G10 | 1.61340 | G10 | 1.77047 | G9 | 1.85451 |
| | | G14 | 1.77047 | G12 | 1.77047 | | | | |
| | vdn | G9 | 29.74 | G5 | 24.80 | G7 | 24.80 | G7 | 25.16 |
| | | G12 | 35.64 | G10 | 44.27 | G10 | 29.74 | G9 | 25.16 |
| | | G14 | 29.74 | G12 | 29.74 | | | | |
| | θgFn | G9 | 0.5951 | G5 | 0.6122 | G7 | 0.6122 | G7 | 0.6103 |
| | | G12 | 0.5824 | G10 | 0.5633 | G10 | 0.5951 | G9 | 0.6103 |
| | | G14 | 0.5951 | G12 | 0.5951 | | | | |
| | vdp | G11 | 20.08 | GS | 20.08 | G6 | 20.81 | G6 | 20.81 |
| | θgFp | G11 | 0.7782 | GS | 0.7782 | G6 | 0.7230 | G6 | 0.7230 |
| | In- | G11 | 0.14427 | GS | 0.14427 | G6 | 0.09183 | G6 | 0.09183 |
| | equality | | | | | | | | |
| | (1) | | | | | | | | |
| | In- | G9 | −0.0047 | G5 | 0.0000 | G7 | 0.0000 | G7 | −0.0010 |
| | equality | G12 | −0.0025 | G10 | 0.0000 | G10 | −0.0047 | G9 | −0.0010 |
| | (6) | G14 | −0.0047 | G12 | 0.0047 | | | | |
| | In- | G9 | −0.08434 | G5 | −0.07182 | G7 | −0.07182 | G7 | −0.06692 |
| | equality | G12 | −0.10331 | G10 | −0.03006 | G10 | −0.08434 | G9 | −0.06692 |
| | (7) | G14 | −0.08434 | G12 | −0.08434 | | | | |

### [Imaging Apparatus]

Next, an embodiment of an imaging apparatus including the optical system L0 according to the present embodiment will be described.

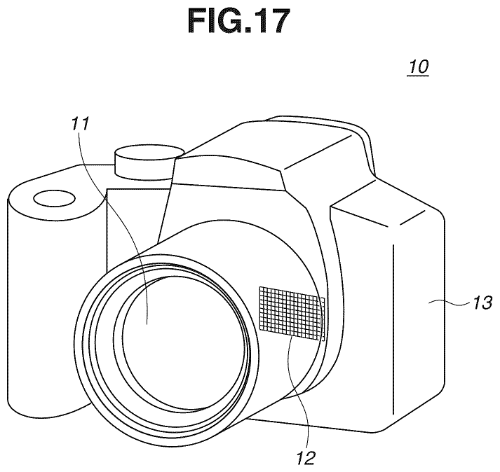

FIG. 17 is a schematic diagram illustrating an imaging apparatus 10 including the optical system L0 according to the present embodiment. The imaging apparatus 10 includes a camera body 13, an optical system 11 corresponding to any one of the first to eighth embodiments described above, and a light receiving element 12 configured to photoelectrically convert an image formed by the optical system 11.

The imaging apparatus 10 according to the present embodiment can obtain a high-quality image formed by the optical system 11 configured as a wide-angle optical system with enhanced distortion correction and improved relative illumination.

It should be noted that an image sensor such as a CCD or CMOS sensor may be used as the light receiving element 12. In this case, various aberrations such as distortion and chromatic aberration in an image acquired by the light receiving element 12 can be corrected using, for example, an electric method, thereby producing an output image with improved image quality.

It should be noted that the above-described optical system L0 according to each embodiment is applicable to not only the digital still camera illustrated in FIG. 17 but also various optical apparatuses, such as silver-halide film cameras, video cameras, and telescopes. Further, a fixed-lens or interchangeable-lens camera may be employed.

### [Lens Apparatus]

Next, an embodiment of a lens apparatus including the optical system L0 according to the present embodiment will be described.

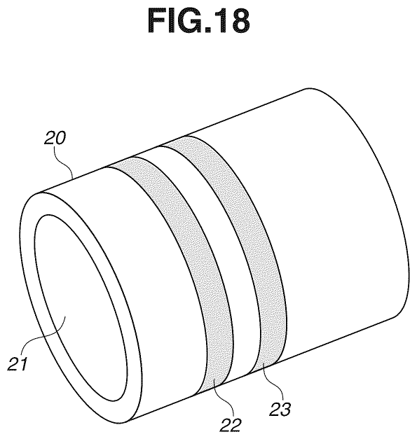

FIG. 18 is an external schematic diagram illustrating a lens apparatus 20 including the optical system L0 according to the present embodiment. The lens apparatus 20 illustrated in FIG. 18 is a so-called interchangeable lens that is removably mounted to a camera body (not illustrated).

The lens apparatus 20 includes an imaging optical system 21 corresponding to any one of the first to eighth embodiments described above. The lens apparatus 20 includes a focus operation unit 22 and an operation unit 23 for changing an imaging mode.

When the focus operation unit 22 is operated by the user, the arrangement of the imaging optical system 21 is mechanically or electrically changed, thereby changing the focal position. It should be noted that the user may operate the operation unit 23 to change the arrangement of lens units in the imaging optical system 21 for a purpose other than focusing. For example, the arrangement of lens units in the imaging optical system 21 may be mechanically or electrically changed based on an operation on the operation unit 23 to change aberrations in the imaging optical system 21. In this case, the focus position can remain substantially unchanged.

While various embodiments of the present disclosure have been described, the present disclosure is not limited to these embodiments, and various combinations, modifications, and alterations are possible within the scope of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-146479, filed Aug. 28, 2024, which is hereby incorporated by reference herein in its entirety.

What is claimed is:

1. A system consisting of a front lens unit having positive refractive power, a first focusing unit having positive refractive power, and a rear lens unit, arranged in order from an object side to an image side,
wherein, during focusing from infinity to a close distance, the first focusing unit moves with respect to an image plane so that a space between the front lens unit and the first focusing unit and a space between the first focusing unit and the rear lens unit change,
wherein, during focusing from infinity to a close distance, the rear lens unit remains stationary with respect to the image plane,
wherein an aperture stop is included and arranged within the front lens unit or adjacent to an image side of the front lens unit,
wherein the front lens unit includes a positive lens Gp, and
wherein the following inequality is satisfied:
$$0.07 < Δθ gFp < 0.250 ,$$
where νdp is an Abbe number of a material of the positive lens Gp, θgFp is a partial dispersion ratio, ΔθgFp is an anomalous partial dispersibility, ΔθgFp=θgFp−(B3×νdp³+B2×νdp²+B1×νdp+B0), B3=−1.665×10⁻⁷, B2=5.213×10⁻⁵, B1=−5.656×10⁻³, and B0=7.278×10⁻¹.

2. The system according to claim 1, wherein the following inequality is satisfied:
$$0.1 < sk / f < 1.80 ,$$
where sk is an air-equivalent back focus of the system at infinity focus, and f is a focal length of the entire system at infinity focus.

3. The system according to claim 1, wherein the following inequality is satisfied,
$$0.3 < fLF / fLFR < 3. ,$$
where fLF is a focal length of the front lens unit, and fLFR is a focal length of the first focusing unit.

4. The system according to claim 1, wherein the following inequality is satisfied:
$$- 1.50 < f / fLR < 1.5 ,$$
where f is a focal length of the entire system, and fLR is a focal length of the rear lens unit.

5. The system according to claim 1, wherein the first focusing unit includes at least two positive lenses and at least one negative lens.

6. The system according to claim 1,
wherein an object-side lens surface of a lens arranged closest to the object side within the first focusing unit has a concave shape toward the object side,
wherein an image-side lens surface of a lens arranged closest to the image side within the first focusing unit has a convex shape toward the image side, and
wherein the following inequality is satisfied:
$$- 1.50 < ( RLFR 2 - RLFR 1 ) / ( RLFR 2 + RLFR 1 ) < 1.5 ,$$
where RLFR1 is a radius of curvature of the object-side lens surface, and RLFR2 is a radius of curvature of the image-side lens surface.

7. The system according to claim 1,
wherein at least one of the front lens unit and the first focusing unit includes a negative lens Gn, and
wherein the following inequalities are satisfied:
$$- 0.2 \; 00 < Ndn - ( - 1.454 \times 1 {0}^{- 2} \times vdn + 2.287 ) < 0.05 ; and$$
$$- 0. 15 < Δθ gFn < 0.015 ,$$
where Ndn is a refractive index of a material of the negative lens Gn at the d-line, νdn is an Abbe number, θgFn is a partial dispersion ratio with respect to the g-line and the F-line, ΔθgFn is an anomalous partial dispersibility, and ΔθgFn=θgFn−(−2.511×10⁻³×νdn+0.674).

8. The system according to claim 7, wherein the front lens unit includes at least one negative lens Gn.

9. The system according to claim 1, wherein the first focusing unit includes at least one negative lens Gn.

10. The system according to claim 1, wherein the following inequality is satisfied:
$$0.5 < ( 1 - β {LFR}^{2} ) \times β {LR}^{2} < 2.50 ,$$
where βLFR is a lateral magnification of the first focusing unit at infinity focus, and βLR is a lateral magnification of the rear lens unit at infinity focus.

11. The system according to claim 1, wherein at least one of the aperture stop and the positive lens Gp remains stationary with respect to the image plane during focusing.

12. The system according to claim 1, wherein the following inequality is satisfied:
$$0. < sk / \vert fLR \vert < 0. 80 ,$$
where sk is an air-equivalent back focus of the system at infinity focus, and fLR is a focal length of the rear lens unit at infinity focus.

13. The system according to claim 1, wherein the following inequality is satisfied:
$$0.2 < \sum Dair / ( L - sk ) < 0.70 ,$$
where ΣDair is a total air gap along an axis from an object-side lens surface of a lens arranged closest to the object side within the front lens unit to an image-side lens surface of a lens arranged closest to the image side within the rear lens unit, L is a total length of the system, and sk is an air-equivalent back focus of the system at infinity focus.

14. The system according to claim 1, wherein the following inequality is satisfied:
$$1.5 < L / f < 15.00 ,$$
where L is a total length of the system, and f is a focal length of the entire system.

15. The system according to claim 1,
wherein the first focusing unit includes the positive lens G2p, and
wherein the following inequality is satisfied:
$$60. < vd 2 p < 100.00 ,$$
where νd2p is an Abbe number of a material of the positive lens G2p.

16. The system according to claim 1, wherein the following inequality is satisfied:
$$- 0.2 \; 00 < MLFR / DSP < - 0.005 ,$$
where MLFR is an amount of movement of the first focusing unit during focusing from infinity to an object distance corresponding to a lateral magnification of −0.1 in the entire system, the amount of movement of the first focusing unit to the image side during focusing from infinity to the object distance corresponding to a lateral magnification of −0.1 in the entire system is defined to have a positive sign, and DSP is a space along an axis from the aperture stop to an image-side lens surface of a lens arranged closest to the image side within the system at infinity focus.

17. The system according to claim 1,
wherein the front lens unit includes the negative lens Gln, and
wherein the following inequality is satisfied:
$$60. < vd 1 n < 100. ,$$
where νd1n is an Abbe number of the negative lens Gln.

18. The system according to claim 1, wherein the following inequality is satisfied:
$$0.5 < fLFR / f < 3.00 ,$$
where fLFR is a focal length of the first focusing unit, and f is a focal length of the entire system.

19. The system according to claim 1, wherein the following inequality is satisfied:
$$0.3 < ( DSP + sk ) / L < 0.80 ,$$
where DSP is a space along an axis from the aperture stop to an image-side lens surface of a lens arranged closest to the image side within the system at infinity focus, sk is an air-equivalent back focus, and L is a total length of the system.

20. The system according to claim 1, wherein the following inequality is satisfied:
$$0.5 < fLF / f < 5.00 ,$$
where fLF is a focal length of the front lens unit, and f is a focal length of the entire system.

21. The system according to claim 1, wherein a negative lens is arranged closest to the image side within the rear lens unit.

22. The system according to claim 1,
wherein the front lens unit includes a compound lens Gcomp consisting of a positive lens, the positive lens Gp, and a negative lens, and
wherein the following inequality is satisfied:
$$0. < f / fGcomp < 2. ,$$
where f is a focal length of the entire system, and fGcomp is a focal length of the compound lens Gcomp.

23. The system according to claim 1,
wherein the front lens unit includes a second focusing unit, and
wherein during focusing from infinity to a close distance, the second focusing unit moves with respect to the image plane.

24. The system according to claim 1, wherein the rear lens unit has positive refractive power.

25. The system according to claim 1, wherein the rear lens unit has negative refractive power.

26. The system according to claim 1,
wherein the front lens unit includes a first lens unit having positive refractive power, a second lens unit having negative refractive power, and a third lens unit having positive refractive power, arranged in order from the object side, and
wherein, during focusing from infinity to a close distance, the second lens unit moves with respect to the image plane so that a space between the first lens unit and the second lens unit and a space between the second lens unit and the third lens unit change.

27. An apparatus comprising a system and a sensor configured to receive an image formed by the system,
wherein the system includes of a front lens unit having positive refractive power, a first focusing unit having positive refractive power, and a rear lens unit, arranged in order from an object side to an image side,
wherein, during focusing from infinity to a close distance, the first focusing unit moves with respect to an image plane so that a space between the front lens unit and the first focusing unit and a space between the first focusing unit and the rear lens unit change,
wherein, during focusing from infinity to a close distance, the rear lens unit remains stationary with respect to the image plane,
wherein an aperture stop is included and arranged within the front lens unit or adjacent to an image side of the front lens unit,
wherein the front lens unit includes a positive lens Gp, and
wherein the following inequality is satisfied:
$$0.07 < Δθ gFp < 0.250 ,$$
where νdp is an Abbe number of a material of the positive lens Gp, θgFp is a partial dispersion ratio, ΔθgFp is an anomalous partial dispersibility, ΔθgFp=θgFp−(B3×νdp³+B2×νdp²+B1×νdp+B0), B3=−1.665×10⁻⁷, B2=5.213×10⁻⁵, B1=−5.656×10⁻³, and B0=7.278×10⁻¹.
